(19) United States
(12) Patent Application Publication
(10) Pub. No.: US 2013/0182311 A1
(43) Pub. Date: Jul. 18, 2013

(54) ELECTROPHORETIC DISPLAY

(71) Applicants: Akihiro Mochizuki, Louisville, CO (US); Laura Päit, Tallinn (EE); Madis Marius Vahtre, Tartu (EE)

(72) Inventors: Akihiro Mochizuki, Louisville, CO (US); Laura Päit, Tallinn (EE); Madis Marius Vahtre, Tartu (EE)

(73) Assignee: Visitret Displays OU, Tartu (EE)

(21) Appl. No.: 13/349,489

(22) Filed: Jan. 12, 2012

(51) Int. Cl. G02F 1/167

(52) U.S. Cl. 359/296

(57) ABSTRACT

New type of electrophoretic display mode is disclosed in this Invention. Introducing transparent medium in an electrophoresis technology, diversity application type of full motion video, full-color image capable electrophoretic display system is realized. New concept of optical switching element based on ferroelectric coupling torque enables both crisp full motion video image and non-power based still image. This display configuration is also effective to apply large billboard displays with significant power saving.

### FIELD OF THE INVENTION

This present invention relates to electrophoretic displays whose driving torque is originated from a ferroelectric coupling base, and their specific structure as both a reflective type and transparent type of displays.

### BACKGROUND OF THE INVENTION

Memory type display devices are attracting intense research and product consideration from the beginning of flat panel display industry due to the advantage in power consumption and readability under sun light ambient luminance condition. Some liquid crystal displays are being used for this purpose with their memory function. In past several years, some types of electrophoretic displays are widely in use, particularly in as so-called e-reader displays.

A memory function based reflective display technology is suitable for display devices specifically for character displays just as paper like image. Reflective nature of display image is also very suitable for replacement of paper media that is strongly required in terms of saving paper resources as well as electronic energy power saving point of view. A replacement of paper media point of view, it is quite natural that so-called an e-paper device has a display function of only still image. A memory function of those e-paper types of display modules saves their power consumption significantly thanks to their memory function. This significant power saving characteristic property is also good match with replacement of paper media.

On the other hand, a paper like electronic display device is strongly expected to have a function of so-called full color. It is quite natural requirement for an electronic paper type display screen to show full color image shown in a paper media. A full color characteristic property is one of the challenges for most of memory types or electrophoretic display devices. In principle, a memory function by display device medium does not show straightforward compatibility with full color display function. In most of memory type display technologies are based on bistability of display medium itself. Consequently, multiple screen luminance level display technology and memory state display technology have a fundamental difference in their principle of display functions. A typical memory function of display device itself uses so-called bi-stability, or alternative of two stable states. Therefore, memory function and gray scale reproducing capability based on multiple state stable states are incompatible. Regardless fundamental issue of multiple state stability, it is quite natural full color image on an e-reader is required. In order to obtain full-color function with state-of-the-arts technologies, a micro-color filter in conjunction with sub-pixels technology is widely used. This technology is based on spatial resolution limitation of human eyes. This state-of-the-arts technology is good enough to be used for so-called e-reader application based on bi-stability type display technology as long as it is applied to still images. However, unlike back light type display devices, reflective display's color recognition function is entirely dependent on ambient light luminance and major wavelength. Moreover, use of sub-pixel reduces image resolution at least to one third compared to the original image resolution. Therefore, for most of reflective displays, obtaining reasonable color purity level with good enough luminance display needs entirely new concept to get rid of its intrinsic characteristic properties.

Moreover, even an e-paper application, moving picture or video image reproduction is also somehow natural requirement in terms of required function as an e-reader. Under above requirements, entirely new types of power saving type displays with keeping good enough balance with memory type display's advantages are being required as an emerging technology.

Current so-called e-reader type display technologies are also expected to be applied digital signage type large bill board displays. As is well known, most of bill board types of large screen displays need specific illumination regardless self-emission and/or illumination system to enhance reflective nature of the screen. Although additional illumination system is required, a reflective display system keeps its specific advantage under bright enough luminance environment which is usual in fine mid-day in most of places worldwide. Of course, night time and very dark environment, more or less, specific illumination system is required. Even if such an illumination system is required, effective surface reflection of reflective base display gives more effective right reflection, resulting in significant power saving effect for large bill board types of display systems. Under current energy saving requirement situation in general, this better reflectivity is even effective for display systems required specific illumination systems.

The inventors of this application explained some fundamental aspects of this type of technology in a copending application Ser. No. 13/337,551, filed Dec. 27, 2011. The disclosure of that application is incorporated herein in its entirety.

### SUMMARY OF THE INVENTION

The invention is directed to providing solutions to the problems discussed above. Based upon memory type reflective display's intrinsic function, this invention enables both reflective and transmissive modes of full color, full motion video image displays. As described above, one of the most difficulties of memory types display systems to obtain good enough full-color capability and good enough motion video image capability is their very slow optical response nature. Similar to conventional liquid crystal display (LCD) systems, slow optical response provides specific display image artifact. Current known electrophoretic display systems are even slower than that of typical LCD systems. Unfortunately, this naturally leads difficulty for an electrophoretic display providing good enough full-color function and good enough motion video image function.

One significance of this invention is introduction of a new type of full-color, full motion video image display based upon a ferroelectric coupling torque in an electrophoresis. Our theoretical research established 100 to 1,000 times faster optical response in intrinsically memory type of electrophoretic display system compared to current known electrophoretic display systems. This extremely fast optical response is realized by introducing ferroelectric coupling torque with externally applied electric field to display medium. Based upon the ferroelectric coupling torque, this invention provides specific display element structures which enable both reflective and transmissive electrophoresis based displays. The new structure includes an incident light control element, a sustaining medium of the incident light control element, a transparent color filter element, a reflective color filter element, and drive electronic element.

This invention provides both theoretical and empirical configuration of extremely fast optical response in both transmissive and reflective modes of displays depending on ambient light conditions. Thanks to the new display configuration, not only extremely fast optical response, but also practical power saving display devices with illumination and full motion video image with full-color function are realized.

### BRIEF DESCRIPTION OF THE DRAWINGS

FIG. 1 shows a model of ferroelectric coupling torque.

FIG. 2 shows ferroelectric coupling torque in an electrophoresis environment.

FIG. 3 shows latching behavior of ferroelectric coupling torque.

FIG. 4 shows ferroelectric coupling torque in elastomer environment.

FIG. 5 shows ferroelectric coupling torque in Non-Newtonian fluid environment.

FIG. 6 shows a color reproduction method using color filters.

FIG. 7 shows a color reproduction method using multiple colored particles.

FIG. 8 shows a basic structure of transparent electrophoretic display medium.

FIG. 9 shows a basic structure of transparent electrophoretic display medium showing color image.

FIG. 10 shows a basic structure of transparent electrophoretic display medium showing gray shades.

FIG. 11 shows a plate like shaped ferroelectric element.

FIG. 12 shows a plate like shaped ferroelectric element switched by externally applied electric field.

FIG. 13 (a) shows a reflective mode of the new display configuration having a plate like element with one side covered by a white light scattering layer.

FIG. 13 (b) shows a reflective mode of the new display configuration having a plate like element with both sides covered by a white light scattering layer.

FIG. 14 (a) shows a transmissive mode of the new display configuration having a plate like element with one side covered by a black light absorption layer.

FIG. 14 (b) shows a transmissive mode of the new display configuration having a plate like element with both sides covered by a black light absorption layer.

FIG. 15 (a) shows a transflective mode of the new display configuration having a plate like element with one side covered by a white light scattering layer.

FIG. 15 (b) shows a transflective mode of the new display configuration having a plate like element with one side covered by a white light scattering layer and the other side coved by a black light absorption layer.

FIG. 15 (c) shows a transflective mode of the new display configuration having a plate like element with one side covered by a white light scattering layer and the other side coved by a black light absorption layer and equipped with both additive primary color mixing color filters on the transparent electrodes and subtract primary color mixing color filters on the reflective electrodes.

FIG. 16 shows the measurement set-up for basic display performance of samples.

### DETAILED DESCRIPTION OF THE INVENTION

### Analysis of Specific Applications of the Technology

This invention was based on ferroelectric coupling torqued electrophoresis phenomenon. Utilizing the ferroelectric coupling torque as drive torque, both reflective and transmissive types of displays are achieved.

(a) e-Reader

This category of application has quite long history starting from use of black and white type LCD modules. In recent several years, memory types of electrophoretic displays are widely used in this category of application. The major benefit of the specific memory type electrophoretic display in this application is its paper like appearance that is relatively good reflectivity with somehow milky white light scattering as well as black light absorption at letter portion. The memory function of the display element saves display module power consumption. This memory effect enables this type e-reader similar to a paper based book. Therefore, the most important requirement for this particular category of application is stable memory effect of display element and good enough light scattering for image background with good enough light absorption for letter portions for good enough readability. This type of technology is disclosed by many published documentations such as “Advances in Microencapsulated Electrophoretic Ink for Flexible Electronic Paper Displays”; M. D. McCreary, International Meeting of Information Display (IMID) pp. 234-235, (2005), “Electrophoretic Ink: A printable Display Material”; B. Comiskey, et. al., Society for Information Display (SID) Technical Digest pp. 75, (1997), and so on.

Faster image writing time or screen refresh time is also important, but it is dependent on number of pixels, and also driving method in a display medium's memory function type display. In general, this particular application is as long as replacement of paper based books, writing time is secondary requirement. More important requirement than writing time is multi-color and/or full-color reproduction.

Regardless tremendous development efforts for good enough color reproduction function establishment such as known as U.S. Pat. Nos. 7,167,155 “Color electrophoretic displays”, 7,791,789 “Multi-color electrophoretic displays and materials for making the same”, and 8,040,594 “Multi-color electrophoretic displays”, quality of color of this type of display is still under development. Since, providing good color purity and good enough color luminance are not easy for reflective type displays. In particular, subtract color reproduction is entirely dependent on ambient incident light color purity and screen luminance. On the other hand, backlight based LCDs have established their good enough color reproduction with combination between micro-color filter and color filter spectra fitting backlight unit system. Although backlight power consumption as well as refresh of screen image driving sacrifices significant amount of power, color reproducibility is fairly good regardless ambient light conditions. Current available electrophoretic display technologies still have significant advantages in their power consumption, however, color image quality is pretty poor compared to those of LCD images due to subtract reflection based color reproduction. In particular color reproduction by well-known technology that is using micro-color filter also decreases significant light throughput, resulting in dimming of screen luminance. For reflective type displays using ambient light as their light source, this light absorption by color filters provides significant drawback in terms of poor screen luminance. In order to avoid screen luminance reduction by using color filter, some experiments are using selective reflection of incident light to reproduce multi-color. International Application Publication No. WO 2008/107989 discloses three-layer stacking multi-color system using selective reflection of cholesteric liquid crystals. This method does not sacrifice image resolution by micro-color filter sub-pixels, and provide relatively large light throughput. However, this method has significant limitation in color purity due to the nature of cholesteric liquid crystal material's selective light reflection. Theoretically, selective reflection by cholesteric liquid crystal's helix has wide spectra distribution, so that obtained selective light reflection includes wide variety of light wavelength, resulting in somehow non-vivid color. Therefore, establishment of real meaning of replacement of paper based book requires some specific balance between current electrophoretic display's power saving benefit and current backlight based color LCD's superior color purity.

Although it is secondary requirement as an e-reader, motion video image capability makes this category of application much wider and productive in terms of content application development. The biggest challenge on motion video capability in the memory based electrophoretic display is inconsistency of the biggest benefit of a memory based electrophoretic display. Therefore, an electrophoretic display has been used for black/white based e-deader due to its display medium memory effect. This memory function is very effective to show still image just like current paper based books. On the other hand, reproducing motion video image requires time based image rewriting that requires a certain level of power consumption. Moreover, due to continuous image refresh requirement, display medium's memory effect is even avoidable matter. Therefore, in general for motion video image reproducing, memory function is not preferable. In order to realize practical and power saving motion video image multi-color and/or full-color displays, the specific balance between power consumption and display image performance is most necessary.

(b) Industrial Displays

This category of application actually has wide variety of display module types as well as their size and use environment. There are wide varieties of applications including traditional mechanical meter types, relatively new transparent type display unit to a pop type advertising display units. One is indicator types of application. The other application is so-called command control displays using relatively large sized screen such as described by Mike DeMario, et. al., “Large LCD Displays for Collaboration and Situational Awareness in Military Environment”, ADEAC Technical digest pp. 75-77. (2006), and Ian Miller, “VESA Monitor Command and Control Set (MCCS) Standard”, ADEAC Technical Digest pp. 90-93, (2006). This category of application is used for a control panel of measurement equipment, indicator displays for many varieties of measurement systems, vending machine displays, and so on. In particular, battery driven measurement machine has great benefit from extremely low power consumption type display module. This particular category's application usually requires relatively simple display contents such as alpha numeric and/or simple animation. A more concrete example is product price display and/or brief description purpose of displays called as a shelf display mainly for a glossary store or a retail shop. Relatively simple content of display such as pricing, product name and/or very brief product description are major contents. The most required performance for this category of display unit is good enough readability and extremely small power consumption. The other application is for product specification description purpose in replacing paper brochure such as specification for car sales. This type of application requires very high resolution of image as well as high information content with minimum power consumption. In the nature of this category of display devices, module design is highly customized and specialized to fit for specific equipment and/or occasion.

In spite of specific category, this category of display unit needs almost zero power while the display content is shown in the screen. On the other hand, this category of display does not require frequent refresh which means still images are of the most important requirement. Some applications would require multi-color, or even full-color, but usually not requires any animation function.

Also in these categories of products sometimes require extremely high resolution, high image contents, in particular for specification displays. For relatively low resolution, or small image contents display, a direct drive or small number of multiplexing drive methods are highly economical. For high resolution or high image content display unit, an active drive backplane is suitable. However, an active matrix drive backplane is used for under premise of motion video image or constant refresh type regardless showing motion video image or still image only, except for specific static memory type transistor embedded backplane such as Alex Ching-Wei Lin, et. al., “LTPS circuit integration for system-on-glass LCDs”; Journal of SID 14/4, pp. 353-362, (2006) that does not require image signal re-creation, but keeps one frame image signal at each transistor of the pixel. Although this static RAM type backplane has power saving function, in general refresh type drive trains usually require relatively not small amount of power regardless still image or motion video image reproduction. If the required information content is very high, and no need of refresh, using memory effect of the display medium, but not the transistor's memory effect. This type display medium memory function gives rise to theoretically unlimited number of strove lines.

(c) Large Screen Displays

This category of display module is usually in use for large billboard types of display. Both indoor and outdoor types are in use for large screen displays. One of the remarkable benefits of memory type electrophoretic displays for this particular application is its low power consumption during still image display. Unlike refresh type display unit, as long as the display image is still image, memory type electrophoretic display itself has zero power consumption. Most of usual application of billboard type display has large display screen size, and in general display power consumption is in proportion to screen area (screen size). Therefore, memory based electrophoretic larger display provides relatively lower power consumption benefit in comparison with refresh types of display unit. Moreover, memory type electrophoretic display is based upon its use model as a reflective display, so that as long as ambient luminance is good enough, even reflective display could save illumination light power. Usually, this illumination power is very large, so that power saving of illumination light is significant. Under dark ambient luminance condition, unlike self-emission types of display unit, electrophoretic display unit requires specific illumination light system. Even such an electrophoretic display unit requires an illumination system, as long as more efficient reflectivity is implemented, still its low power consumption benefit is considerable. In order to realize high enough reflectivity while keeping other required display performance such as color purity, number of colors so on, entirely new technology is highly expected.

A memory type reflective electrophoretic display is potentially good match with these types of large billboard display application. The difficulties in current known electrophoretic display technologies are overcome as follows:

### Technical Requirements of Each Application

(a) e-Reader

This category's technical missing matters are both color reproduction and motion video image capability. As described above, in principle, both memory effect which is good for power saving and motion video image capability which requires video rate of refresh are inconsistent each other. Most of pixelated matrix type displays need memory effect in some sense to keep good enough image quality regardless still image or motion video images. For instance, TFT (Thin Film Transistor) drive backplane uses at least single frame scan time of charge memory effect to avoid image degradation during frame to frame time interval. Thanks to TFT backplane side of memory effect, display medium has no need to have memory effect as the material. Instead of keeping memory function at display medium, TFT backplane keeps enough charge to keep the display medium image status until next frame of charge excitation is ready. On the other hand, without TFT backplanes, and without memory effect in display medium, much faster refresh or scrolling is necessary to keep image on the display screen to maintain good enough image quality. So-called multiplexing drive method in conjunction with passive matrix backplane is this case. In the multiplexing driving case, actually, some certain slow optical response of display medium is better to keep good enough image quality. Since extremely fast pulse rate such as several tens of kHz is usually applied for this type of driving, if display medium has optical response of sub-milliseconds, every time several kHz of excitation voltage pulse is applied, the display show small but crisp flickering. Therefore, this type of driving is rather suitable for slower response optical medium to avoid flickering image artifact.

To address this inconsistency, our focused investigation established the followings to solve these technical difficulties. Both of obtaining higher quality of color reproduction and motion video image capability with minimum or acceptable level of sacrificing of image holding power, following are important:
(1) Extremely fast electro-optical response in an electrophoretic based memory type display.
(2) Regardless extremely fast optical response, the display medium should have memory effect which enables shown image keeping without any power.
(3) Regardless of its memory capability, once proper electric signal is applied, the shown image must change its content by the newly applied electric signal.
(4) Good enough compatibility with current established flat panel display technologies

The reason why above four bullet points are effective to solve this category of devices will be discussed below.

(b) Industrial Displays

Most of technical difficulty issue of this category of devices shares with those of e-reader requirement. Depending on specific application, some application requires much wider operational temperature rage compared to that for e-reader. Some application requires much higher contrast ratio compared to that for e-reader, and some application requires more mechanical robustness, and so on. Mainly, this category of specific technical difficulty is related to reliability issues including working environment issue.

One of the examples is gas pump meter display for automobile gas stand. Depending on climate environment, it requires relatively wide tolerance, but in general this particular application requires from −30 C to +75 C of operational temperature range as same as −40 C to +90 C of storage temperature range. Some liquid crystal displays (LCDs) satisfy these requirement at least temperature wise, however, still current commercially available display module has significant difficult to meet with other requirement such as good enough contrast and screen luminance with such a wide temperature range. Moreover, it is very difficult to meet mechanical robustness criterion. Therefore, in general, this category of display module needs to improve extremely wide temperature range requirement without sacrificing display image qualities. Moreover, mechanical robustness is one of the most challenges for all of display modules for this category of display application.

On the other hand, most of this category of display module does not require high color quality required for above e-reader application, moreover does not require motion video image. Therefore, technical difficulties of this category of display unit are keeping high enough contrast ratio and screen luminance in wide temperature range. This category of application has one more important requirement. It is durability to sunlight exposure. Many of these categories of display modules are in use as outdoor applications. Therefore, ultra violet (UV) exposure durability is also very important requirement. In short, following technical requirements are important:
(1) Wide enough both operational and storage temperature ranges.
(2) To keep good enough contrast and screen luminance in the wide enough temperature range.
(3) Sunlight exposure durability.
(4) Large screen displays

(c) Large Screen Displays

The most emerging application of this category is so-called e-signage. Traditionally, this category of application has been well known as a billboard type display screen. A large screen display including outdoor ball-park type score board display to indoor announcement board display, use environment and screen size are widely spread. Technical challenge of this category of display unit should be discussed both in terms of screen size and use environment.

For indoor type, current popular application is E-Signage at public service area such as an airport, a train station, a shopping mall corridor, and so on. These use environments are usually bright enough with ambient luminance, therefore, for most of memory display devices, it is good to use. Since those use environments are mostly kept quite stable ambient luminance condition, reflective type memory displays such as an electrophoretic display would be very effective in terms of its significant power saving capability as well as its consistent color quality based on sub-tract color mixing. Stable and consistent ambient luminance condition makes reflective type displays effective manner. Moreover, such ambient luminance environments are very much predictable of incident light angle to a reflective type display module. This makes reflective efficiency of the display unit maximize as well as consistent color quality. On the other hand, most of self-emission type E-Signage display modules including backlighted LCD module, such high ambient luminance condition degrades original screen image quality. Moreover, depending on ambient illumination spectrum condition, even color purity has not a small influence. Therefore, this particular indoor application field is good for most of memory type reflective display modules. On the other hand, most of self-emission type display modules is good for motion video image reproduction including full-color capability. A memory type displays, in particular a memory type electrophoretic display is very difficult to reproduce both motion video image and full-color image reproduction due to its memory based characteristics.

Above discussions clarify both merits and demerits of both self-emission type displays and memory type reflective displays. Table 1 shows summary of those. As Table 1 clarifies, self-emission type display units are very good in their motion video image reproduction capability, however, image quality is very much dependent on ambient illumination spectra and luminance with consistently large power consumption. On the other hand, memory based reflective display units are very good for color image adjustability and still image power consumption. However, the biggest technical challenge of the memory based reflective display unit is its poor to no motion video capability.

TABLE 1
General comparison of self-emission type and memory based
reflective display for in-door use of E-SIGNAGE application

| | | Memory based |
|---|---|---|
| | Self-emission | reflective display |
| In-door E-SIGNAGE | display | (Current technologies) |
| Still image holding | In proportion to | Zero regardless |
| power consumption | screen size | screen size |
| Motion video image | In proportion to | In proportion to |
| power consumption | screen size | Screen size |
| Color image quality | Dependent on ambient | Consistently good |
| | illumination spectra | |
| Influence of ambient | Difficult to adjust | Adjustable |
| illumination on image | | |
| quality | | |
| Full-color | Good | Poor to not available |
| reproduction | | |
| Motion video image | Good | Poor to not available |
| quality | | |

From above comparison, followings are important for memory based reflective display units of indoor application:

(1) Motion video image should be competitive with that of self-emission type displays.

(2) Full-color reproduction should be available.

### General Approach to Overcome Given Technical Challenges

As discussed above, a memory type reflective display has of its intrinsic advantages for above three categories of applications. Several memory type reflective displays are already known and used as actual display devices. For instance, (a) e-reader application: e-books, (b) industrial displays: glossary store's shelf price tags, (c) Large screen displays: ball park score board, are popular examples. Each actual in use type display unit has its own advantage. On the other hand, each application still requires specific display capability for wider and more effective use of each category's display unit as described above.

The inventors of this invention focused on investigation of most intrinsic technical background or fundamental requirement to solve each category's technical challenge. In this particular consideration, the inventors had the following fundamental mechanism study. Following is the description of the basic approach in this invention.

First of all, each category's technical challenges are sorted out comprehensively. Then, the total requirements are as follows:

(1) Optical response time should be extremely fast to meet with motion video image reproduction.

(2) Keep memory effect for still image holding.

(3) Extremely fast optical response should be realized with current available platform.

(4) Full-color reproduction capability.

(5) Wide enough temperature range.

(6) Durability as an outdoor display unit.

For motion video image reproduction capability, it is not only display media's sole matter, but need to consider drive scheme as well as drive backplane availability. Of course, regardless drive scheme, the display medium is absolutely required fast enough electro-optical switching capability. At the same time, drive train matching capability is also of its important requirement in terms of obtaining practical motion video image capability. For diverse application capability, both active matrix backplane drive such as TFT backplane drive, and passive matrix drive with multiplexing drive scheme are considered. With extremely fast optical response, full-color reproduction becomes realistic even for memory based reflective display system. Although it is not specifically for reflective displays' case, this basic concept has been well known as field sequential color method in these over 50 years. Most of pixelated displays use spatial resolved sub-color system. For instance, backlighted color LCDs, they have sub-pixel structure with each sub-pixel having primary color's color filter such as blue, red and green color filter. Using human eyes' limited spatial resolution, very tiny each primary color sub-pixel synthesizes full color image to human eyes. Field sequential color system uses time resolution instead of spatial resolution. Using human eyes' limited time following resolution, if a single pixel reproduces blue, red, and green color, respectively with extremely fast time frame faster than human eyes' time resolution, the single pixel synthesizes full color image in human brain. Therefore, if memory based reflective display system has fast enough electro-optical response capability faster than human eyes' time resolution, the display provides full-color image to human brain. At the same time, if the display image is still image and not necessary to rewrite for a certain amount of time, the display medium must has memory capability in its medium itself. Both motion video image reproduction and still image reproduction as well as memory function at keeping a still image must be operational applying current state-of-arts technology in order to the display device applicability realistic. Also both wide temperature requirement and durability of sunlight exposure should be basic materials selection matter, although some additional ways to avoid such technical issues are also possible consideration.

Based upon above comprehensive consideration, each principle technical requirement was investigated; how each technical requirement is overcome is as follows:

(a) Extremely Fast Electro-Optical Response to Meet with Field Sequential Color Requirement.

This requires at least 1 ms or shorter optical response time.

This level of electro-optical response is theoretically possible only by dielectric coupling with externally applied electric field and/or ferroelectric coupling with externally applied electric field.

(b) Keeping Effective Memory Effect

In order to keep effective memory effect, there are several ways. One is using magnetic element, one is using switchable molecular structure configuration changes such as cis and trans molecular structure configuration, one is switchable molecular or crystalline structure change, one is ferroelectric phenomenon.

(c) Reliability Requirement

There are proven reliable materials among current on market technologies. Some are materials' intrinsic reliability, some are device module's total performance such as using UV cut filters.

Furthermore, due to reflective display nature, it is not easy to use UV cut filters in front of display screen because of significant light reflection. Moreover, significantly wide temperature range must be dealt with so that display performance change is minimized.

Above analysis of current requirements and current display performance established following new concepts of display configuration.

(1) Electrophoresis based display technology to maximize use of ambient light for the display image.

(2) Transparent optical switching medium to maximize use of ambient or illumination light efficiency.

(3) To achieve both reflective display and transmissive display configuration depending on application and/or display application.

### Theoretical Requirements to Overcome Current Technical Issues

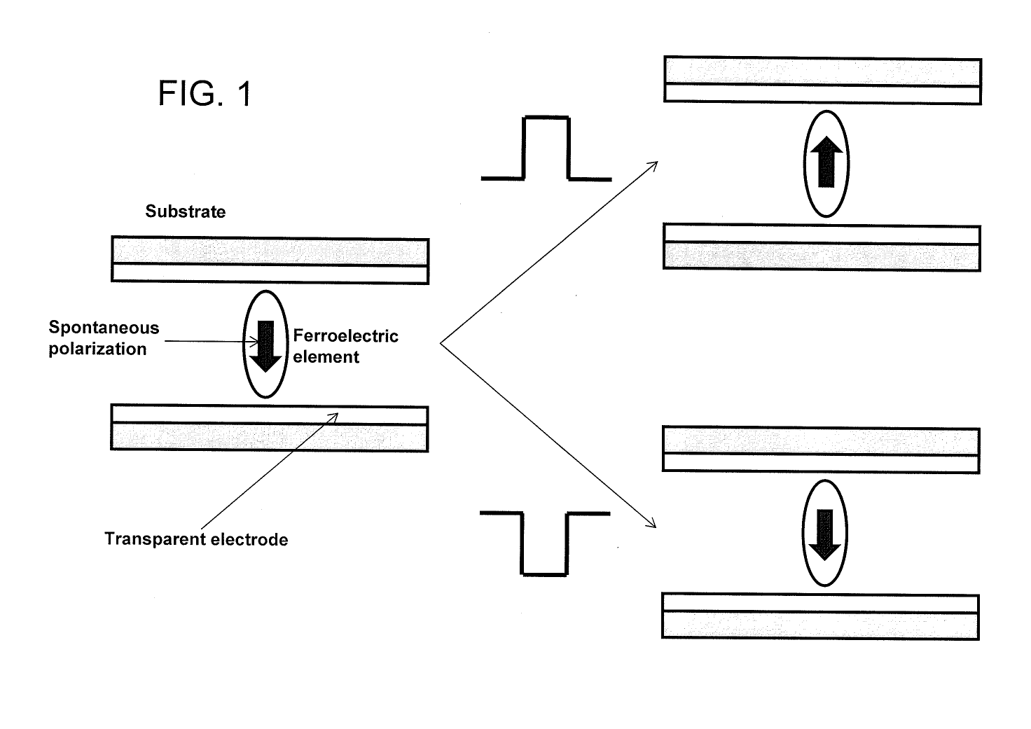

A simple model of ferroelectric coupling torque works like a flip-flop as illustrated in FIG. 1. Spontaneous polarization of the ferroelectric element simply switches its direction by application of an external electric field. When an external electric field of 180 degree different direction with respect to the direction of spontaneous polarization is applied to the element, the element rotates its direction until the spontaneous polarization comes to parallel to the external electric field direction. Therefore, this simple ferroelectric element model is juts a bistable configuration between the upward and downward spontaneous polarization directions. In the simple ferroelectric switching model, once spontaneous polarization switched, thanks to the ferroelectric materials characteristics, the spontaneous polarization direction is preserved as it is even after the externally applied electric field is removed.

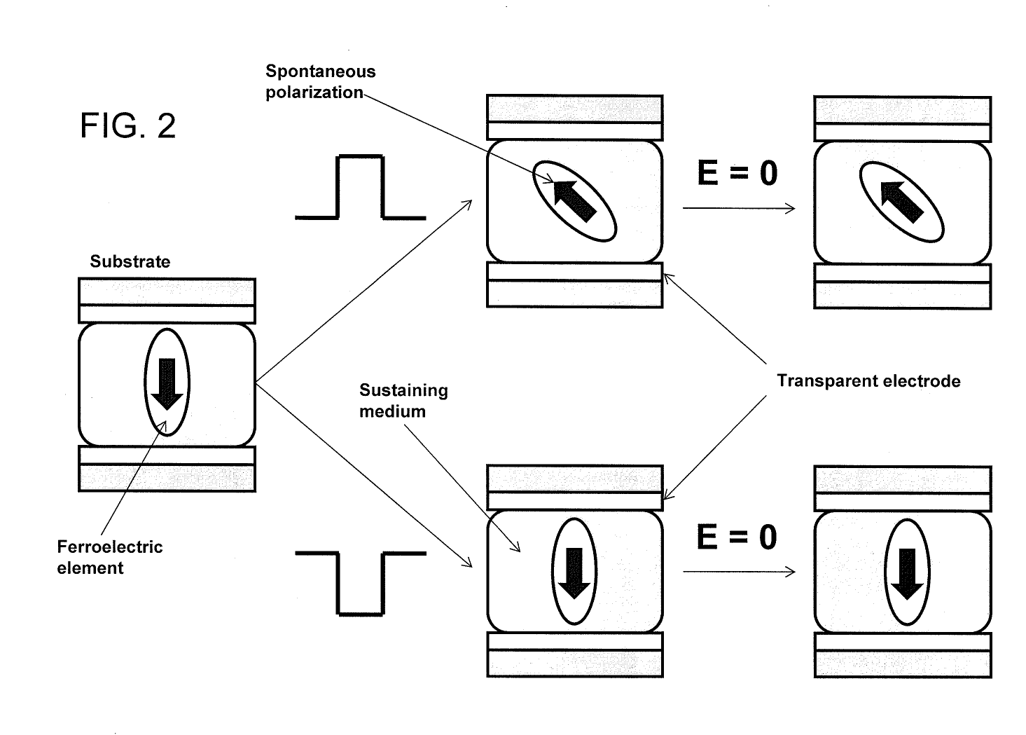

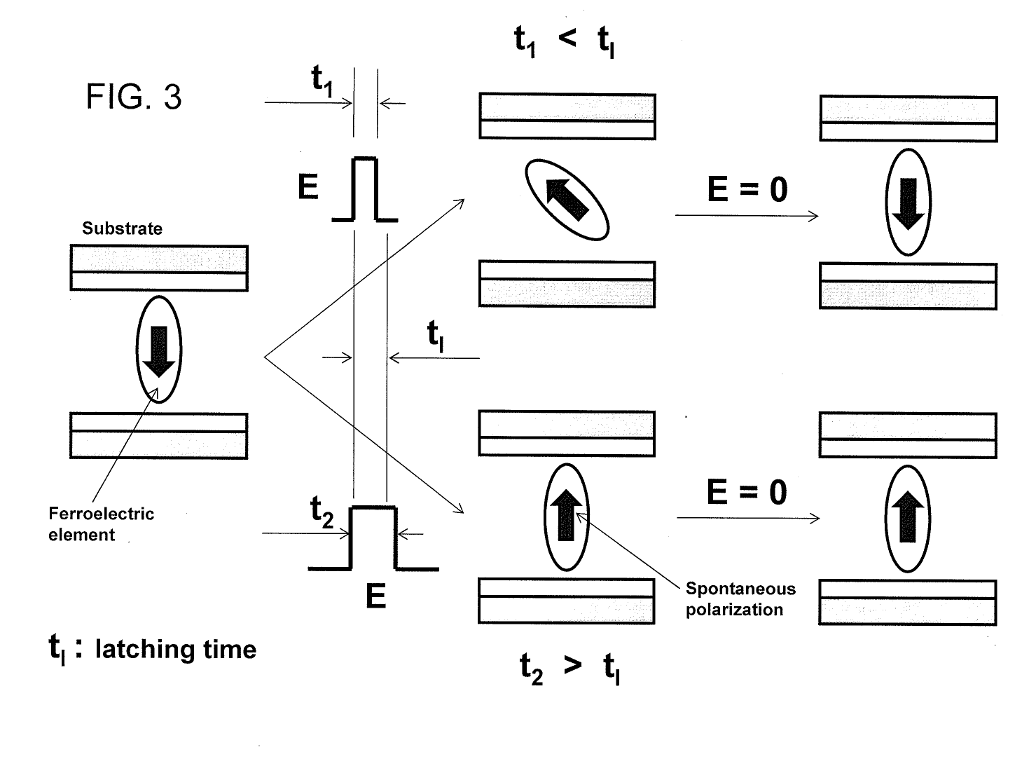

Unlike the simple ferroelectric switching model shown in FIG. 1, in most of electrophoresis environments, the spontaneous polarization switching has some resistive force from the sustaining medium of the switching element, as shown in FIG. 2. This resisting force is originated from the sustaining medium's elastic or rheological properties. When the switching element receives ferroelectric coupling torque created from the externally applied electric field, the element starts its switching. As soon as the switching element starts its switching, the surrounding sustaining medium provides a resisting force by the nature of rheology of an elastic material. This resisting force substantially works as a switching control medium. Also, usual ferroelectric coupling torque works as latching base as illustrated in FIG. 3. If the ferroelectric coupling torque continues working longer than the latching time (in FIG. 3), the ferroelectric element completes its rotation without any sustaining medium environment as illustrated in FIG. 3. If the ferroelectric coupling torque does not continue longer than the latching time, then, the ferroelectric element does not complete its rotation, resulting in no rotation after the externally applied electric field is removed as illustrated in FIG. 3.

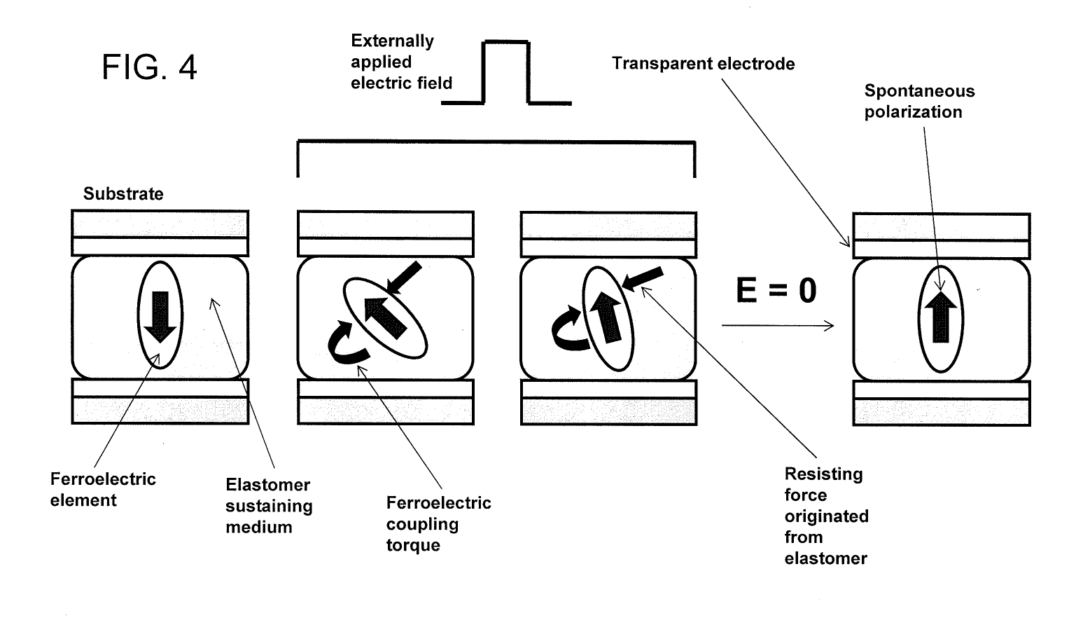

In an electrophoresis environment with a sustaining medium, ferroelectric switching element behavior is a little bit different compared to the configuration without any sustaining medium as illustrated in FIG. 3. Due to rheological phenomenon, the ferroelectric element has resistive force from the sustaining medium. Actual resisting force is depending on nature of the sustaining medium. When the sustaining element is an elastomer, ferroelectric switching element has continuous resisting force during its rotation as shown in FIG. 4. One example is so-called polymer gel sustaining medium. Due to relatively strong elastic constants of a polymer gel sustaining medium, the elastic constants work as competitive force to the ferroelectric coupling torque. Unlike very low viscous fluid, a relatively strong elastic modulus material works both as the competitive force to the ferroelectric coupling torque and the sustaining force maintaining the positions of the ferroelectric particles after their driving torque is removed.

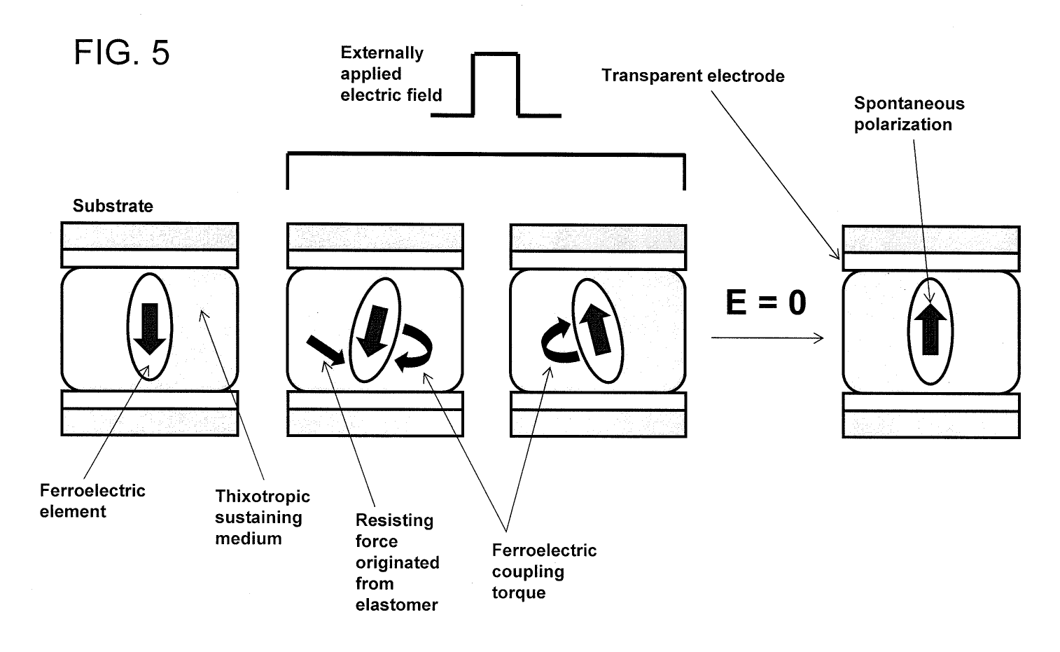

When the sustaining element is a thixotropic medium, the ferroelectric switching element has a significant resisting force only just the beginning of its switching. Once, the ferroelectric switching element starts its movement, then, the thixotropic medium surrounding the ferroelectric switching element shows significant reduction of the resisting force due to the nature of Non-Newtonian fluid as shown in FIG. 5. When a thixotropic sustaining medium is used, the competition between the ferroelectric coupling torque and the elastic resistance of the sustaining medium is basically the same as those for the elastic sustaining media. Only difference between the elastomer medium and the thixotropic medium is competitive force at ferroelectric driving torque is applied. In the case of elastomer, as described above, the competitive force originating from elastomer's elastic constants works constantly. On the other hand, when a thixotropic sustaining medium is used, the major competitive force originating from the thixotropic medium works only when ferroelectric driving torque is removed by eliminating externally applied electric field.

Regardless the type of the sustaining medium, i.e., elastomer or thixotropic, the ferroelectric switching element driving torque with a sustaining medium environment, which is the environment of electrophoresis, is described as follows. The equation below explains just one dimensional force (in the x direction). Since sustaining medium works its resisting force as isotropic manner, other directions, y and z directions forces are expressed in the same manner as the following x direction force.

$$F = {\int }_{0}^{d} \{ {\frac{B}{2} [ \frac{\partial φ}{\partial x} ]}^{2} - D \frac{\partial φ}{\partial x} \} d x + 2 {γα}_{d}^{2} \qquad Eq . 1$$

Here, F is elastic modulus resisting force, B is elastic modulus constant, D is dielectric based constant, γ_{d} is surface steric interaction constant, and ad is mutual interaction between surface and sustaining medium. d is the display medium thickness. In Equation 1, the first integral term represents both elastic energy and electric interaction energy. The second term represents surface interaction energy.

The ferroelectric coupling torque is expressed as Equation 2.

ferroelectric coupling torque=PsE Eq. 2

Accounting for the resisting power of the sustaining medium, the ferroelectric coupling torque expressed as Equation 2 becomes as follows:

ferroelectric coupling torque=PsE/η Eq. 3

Here, η is material's own viscosity. Therefore effective working force is represented as Equation 3.

In an electrophoresis environment, the substantial drive force is a competitive situation between Equation 1 and Equation 3. Actual competitive force needs to take into account kinetic potential factor well known as zeta potential, however, here, it is enough the discuss these two factors to explain the invention.

When sustaining medium of the electrophoretic display is a elastomer, the first term of Equation 1, in particular B works all the way through the ferroelectric element rotation, resulting in some limited switching time due to relatively strong breaking effect. When the sustaining medium of the electrophoretic display is a thixotropic fluid, B works just at the initial stage of the ferroelectric element rotation, and once the ferroelectric element starts moving, suddenly B becomes very small, most of cases, it becomes negligible. It is the specific characteristic property of thixotropic fluid, or widely known as Non Newtonian fluid performance. It is dependent on the required optical switching time to choose which medium is better for a specific application. In general, a thixotropic medium has wider acceptance in terms of switching element shape of its mobility as disclosed in International Application No. PCT/EP2010/057865, which claims priority from Estonian Utility Model application No. EE U201000017. As Equation 1 suggests, not only the elastic resisting force, but also the surface originated energy is also of our consideration. In particular, when the switching element is relatively small, and/or the electrophoretic medium is relatively thin, the surface anchoring energy term takes relatively large role in terms of resisting force. When the switching element size is small such as 20 to 30 microns diameter average, its relative surface area compared to its volume is larger than when the average element size is about 100 microns. Therefore, smaller element size provides larger resisting force than that of larger element size, resulting in slower response time. In general, in order to have faster switching, it is good to use larger element size with a thixotropic fluid as a sustaining medium. Of course, optical switching response is also dependent on dispersed density of element in a sustaining medium, total film thickness in terms of surface anchoring relative contribution, and of course strength of electric field. From theoretical principle point of view, faster optical switching condition is as follows:

(a) Larger switching element.

(b) Use thixotropic sustaining fluid.

(c) Relatively small density of switching element.

(d) Relatively thicker display medium taking into account required strength of electric field.

Larger switching element size makes surface anchoring effect burden of each switching element lighter, use of thixotropic sustaining medium makes resisting force much smaller, relatively small density of switching element makes surface anchoring effect smaller, and thicker display medium also reduces surface anchoring effect mainly from electrodes interface surfaces. However, above factors need to have well enough balance with other required performances as display medium, such as contrast ratio and screen luminance. Here, above discussion is solely for obtaining faster optical switching, and it is obviously required some optimization to make a good balance among several critical requirements as a display medium.

As secondly discussion in terms of having faster optical switching property, it is effective to consider dielectric contribution of the sustaining fluid. As Equation 1 suggests, when dielectric term is large, resisting force F becomes smaller, resulting in faster optical switching. Theoretically, even F is possible to accelerate optical switching if dielectric term's contribution is larger than those of elastic term and surface anchoring term. It is not clear if the dielectric term is larger than those of elastic term's and surface anchoring term's contribution, however, using thixotropic medium case, as discussed above, elastic term's contribution is limited in the very beginning of the switching, therefore, a thixotropic medium provides faster optical switching compared to an elastomer medium in general.

For ferroelectric switching element, it is required to use ferroelectric material. Current available ferroelectric switching element materials are both from dislocation type of ferroelectric or intrinsic ferroelectric materials or order/disorder type of materials. Both have advantages and disadvantages in terms of application to the ferroelectric switching element for an electrophoretic display. Dislocation type ferroelectric materials is in many cases made of an inorganic crystal. BaTiO3 is well known dislocation type of ferroelectric material. In general, dislocation type of ferroelectric materials have relatively large spontaneous polarization, therefore, as Equation 2 suggests, its driving torque is large. Order/disorder type of ferroelectric materials are mainly polymer base or low molecular organic materials. Polyvinyliden fluoride or PVDF is well known as this type of ferroelectric polymer as well as Nylon 11. Some liquid crystal molecules also show this type of ferroelectric performance. In general order/disorder type of ferroelectric materials show relatively small spontaneous polarization, therefore, driving torque is relatively small compared to that of the dislocation type of ferroelectric materials. On the other hand, most of order/disorder type of ferroelectric materials could change their molecular shape relatively easily, resulting in substantially lower viscosity. This lower viscosity effectively compromises small spontaneous polarization.

### Practical Designs

To overcome traditional electrophoretic displays' drawbacks, the inventors thought out new structures for electrophoresis display device based on above discussed theoretical analysis of ferroelectric switching element.

The primary technical issue of current electrophoretic display is non-compatible problem between low power consumption and high image quality including full-color and full motion video image capability as discussed above. In order to solve this intrinsic incompatible situation at an electrophoretic display, the inventors focused on diagnosis of current electrophoretic displays' performance and structure. From display medium configuration, the inventors concluded as follows:

The nature of electrophoresis is colloidal effect in general, and most of colloidal effects are based upon non-transparent mixture base. It is not surprising that an electrophoresis effect shows non-transparent property based upon its dispersing particle nature. One of the most popular electrophoretic display uses black and white particles to make good enough contrast on milky white background. This is very effective to have a bright enough screen luminance using ambient light. On the other hand, milky white light scattering by display elements on an electrophoretic display means non transparent. If it is transparent, it is not expected to have good enough milky white light scattering as a background of the display. Therefore, current conventional electrophoretic displays have an intrinsic problem to have well enough transparent type of display. Under the premise of the current intrinsic requirement of milky white background of reflective type of electrophoretic displays, the inventors sorted out mechanisms of milky white light scattering and color reflectivity and also possible effective light-throughput type of displays. Backlighted transparent type of electrophoretic displays may be one solution.

(a) Light Scattering Entity

Current known electrophoretic displays make effective light scattering of ambient light by using light scattering from switching element surface or loaf of switching elements. This makes display element non-transparent. Since, light scattering from the surface of switching element needs complete coverage of display element to have well enough light scattering. If the coverage is not enough, light scattering strength is weak and could not obtain well enough milky white light scattering. Therefore, current electrophoresis phenomenon based displays are basically required to be non-transparent in their display element.

(b) Color Reproductivity

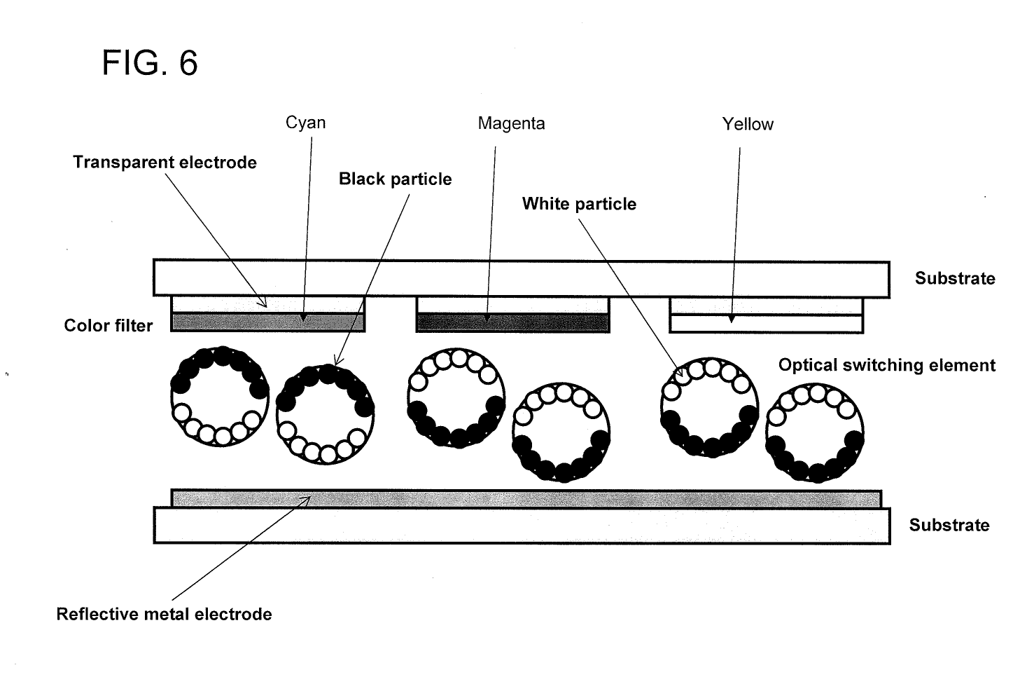

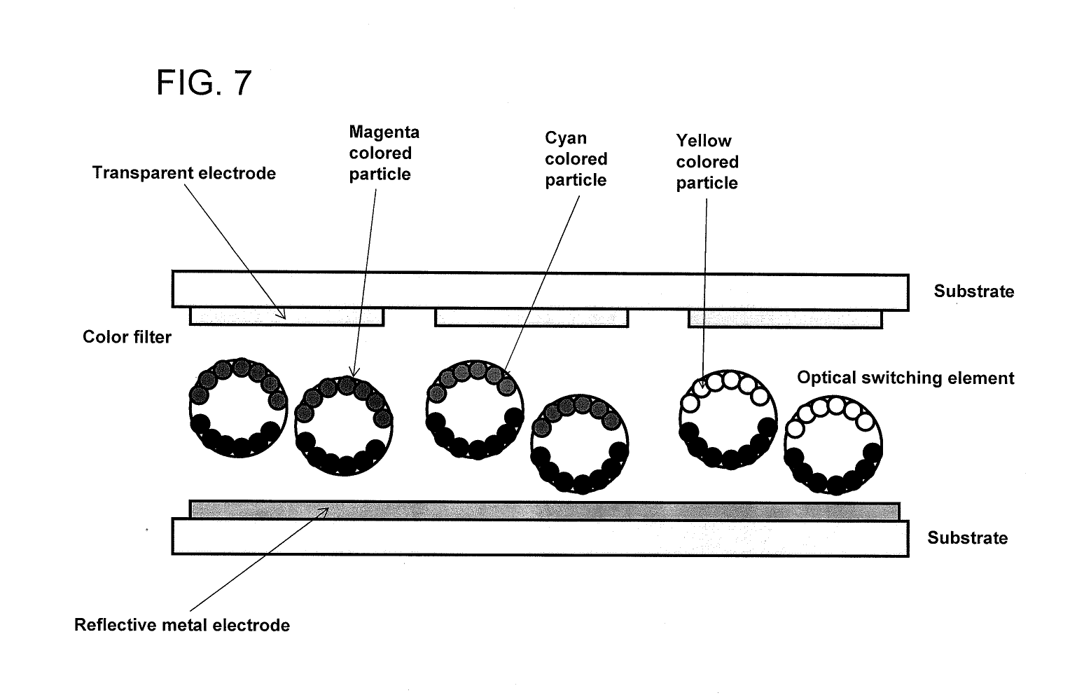

Current known color reproduction on electrophoretic displays uses color filters or multiple colored switching element as shown in FIGS. 6 and 7, respectively. They use light scattering and color absorption, therefore, they are non-transparent display systems.

In order to have light-through type or transparent type electrophoresis display system, the inventors thought out new mechanisms and structural configurations based on a new type of electrophoresis phenomenon. Following discussion explains the new mechanism as well as the new structural configuration.

1. Light Throughput System Mechanism

In order to keep good enough light scattering to obtain good enough screen luminance, an electrophoretic display must have a light scattering mechanism. All of known electrophoresis based display technologies use switching element as the light scattering element. This results in a non-transparent type display. Therefore, the inventors considered another mechanism to have good enough light scattering other than through optical switching elements.

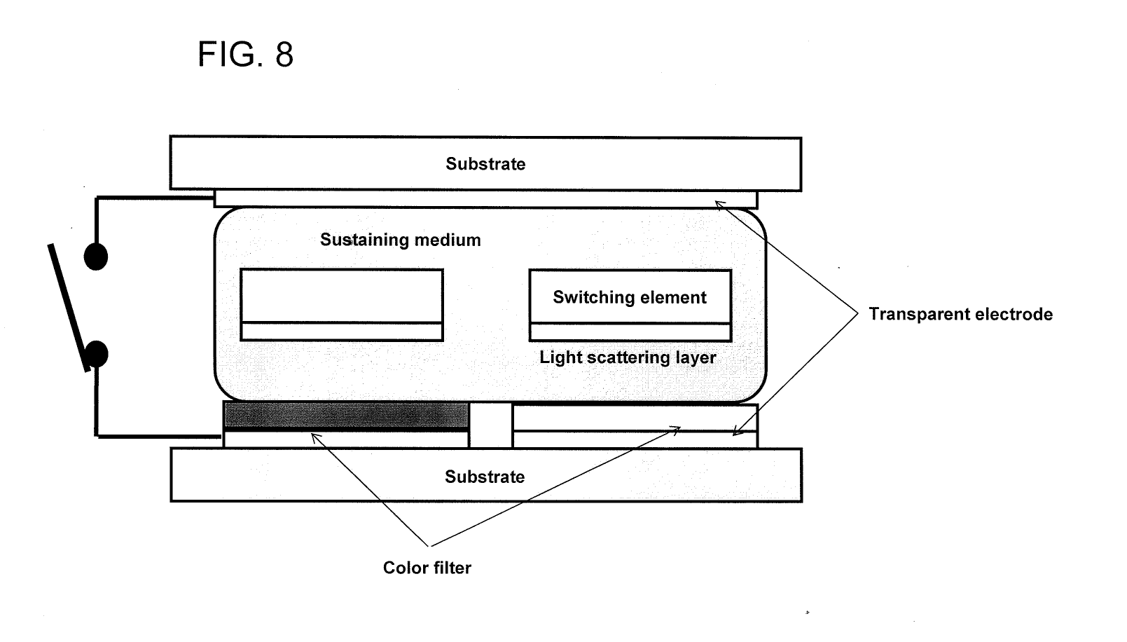

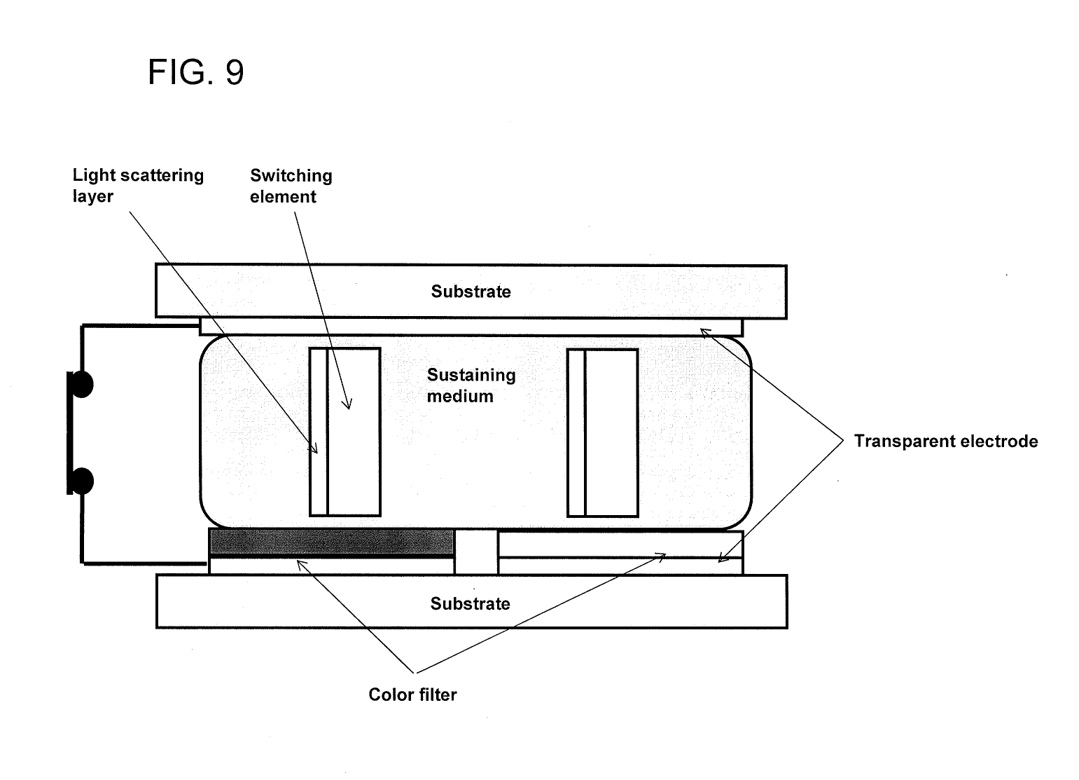

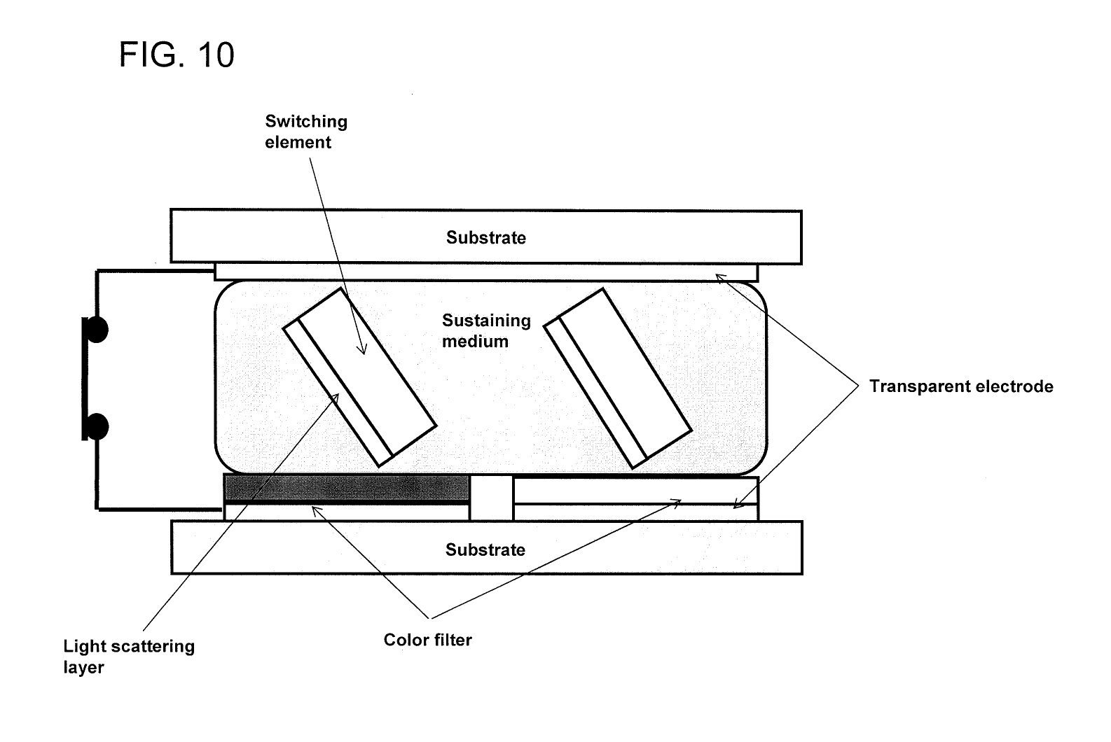

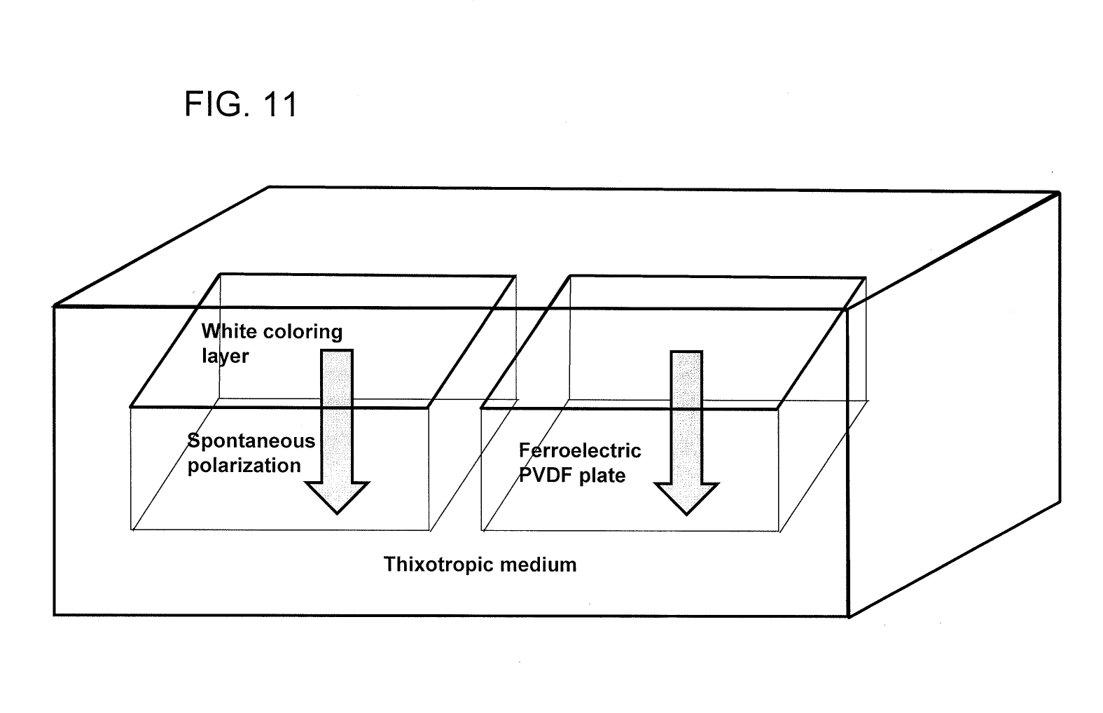

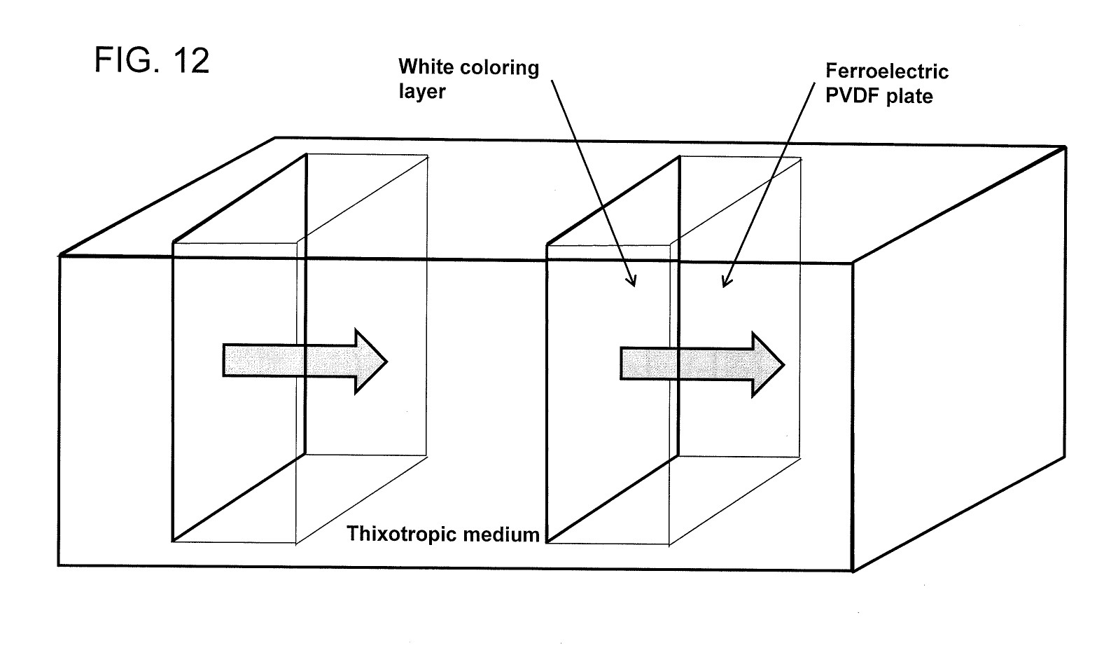

There is another mechanism to have good enough light scattering. It is to use light from the backside of the display elements. As shown in FIG. 8, if ambient light is effectively scattered behind the optical switching elements, the display system could have good enough light scattering performance. In this case, the optical switching element needs to have good enough light throughput to have effective light scattering from the back side of the elements. At the same time, to display black or any color image, the optical switching elements also need to show good enough light intensity of color image. In order to enable both light scattering and color image, the inventors introduced a new concept to an electrophoresis phenomenon in terms of display performance. Instead of using the optical switching element to show milky white light scattering and back image by absorbing ambient light, the optical switching element rather works as light throughput control element as shown in FIGS. 8, 9 and 10, respectively. In this way, the optical switching element works as light blocking, and light passing element instead of light scattering, and light absorbing element. Light scattering and color reproduction function is not from optical switching element, but from the back side. As FIG. 8 illustrates, the optical switching element has plate-like shape. At the initial state, the plate-like element stays almost parallel to the backside of substrate. This configuration enables a light scattering state by ambient light. When a certain voltage is applied to the panel, as FIG. 9 illustrates, the plate like element rotates and comes to vertical state. In this configuration, ambient light passes through to the back side of the panel. In the back side of the panel, color filters are equipped based on subtract color coordination. In FIG. 9, two color filters are illustrated just an example, one is cyan, the other is yellow. In this configuration, both cyan and yellow colors are reflected from the back side of the panel, then the panel reproduces subtract mixed color. FIG. 10 illustrates some middle state of plate like element by choosing proper applied voltage. In this configuration, the intensity of reflected colored light is smaller than that of FIG. 9. Therefore, this configuration provides gray shade of the color reproduction. The plate like switching element should include a ferroelectric material, and its spontaneous polarization is perpendicular to the plate like plane as shown in FIGS. 11 and 12. The two sides of plate like surfaces are covered by white light reflection materials or no particular coating. In case of no particular coating, the plate like material and sustaining medium should have a proper reflective index mismatching to make good enough light scattering at the surface of the plate like element.

2. Color Reproduction Mechanism as a Reflective Display Mode

In this new configuration electrophoretic display system, color reproduction is made by color filter in principle. As FIGS. 8, 9 and 10 illustrate, when, ambient light reached at color filter through the plate like element, the display panel shows a specific color. When the plate like element aligns almost parallel to the back plate, most of ambient light is reflected by the surface of the plate like element, resulting in milky white screen. By arranging color filters based on sub-tract color mixing system, this display reproduces full color image.

3. Color Reproduction, Mechanism as a Transmissive Display Mode

One significant benefit of electrophoretic display is its memory display function. Memory type of display enables significant power saving. In particular for a still image display in a bright enough environment, this type of display is very effective. On the other hand, without bright enough ambient light condition such as night time, in a dark room, additional illumination source is required. Moreover, for motion video image, the memory function of the electrophoretic display is even harmful. For motion video image reproduction, continuous refreshing of image is necessary, therefore, no display memory effect is necessary. Therefore, for motion video image reproduction, and in dark ambient light condition, more or less additional power consumption is inevitable. However, even in such a case, higher illuminator light efficiency saves significant amount of power. Depending on ambient light condition, a display has at least two functions: one is reflective display function under bright enough ambient light condition; and the other is with illuminator under dark ambient light condition. Significant power saving is achieved in either case.

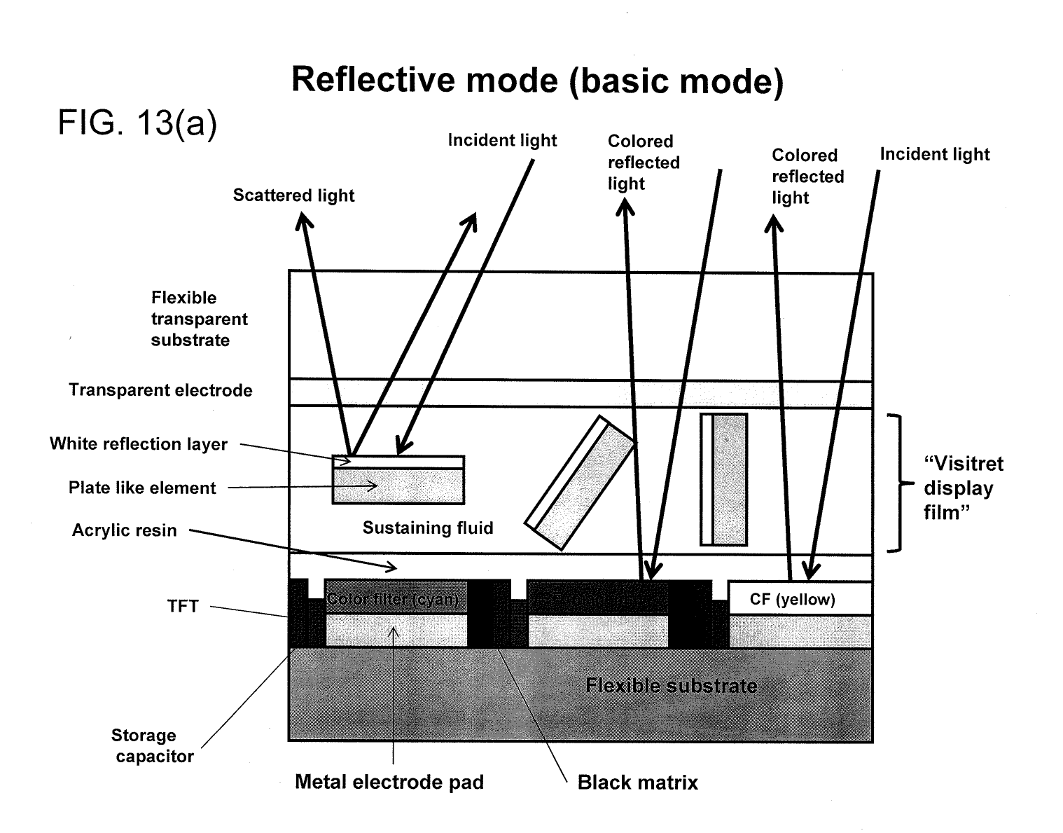

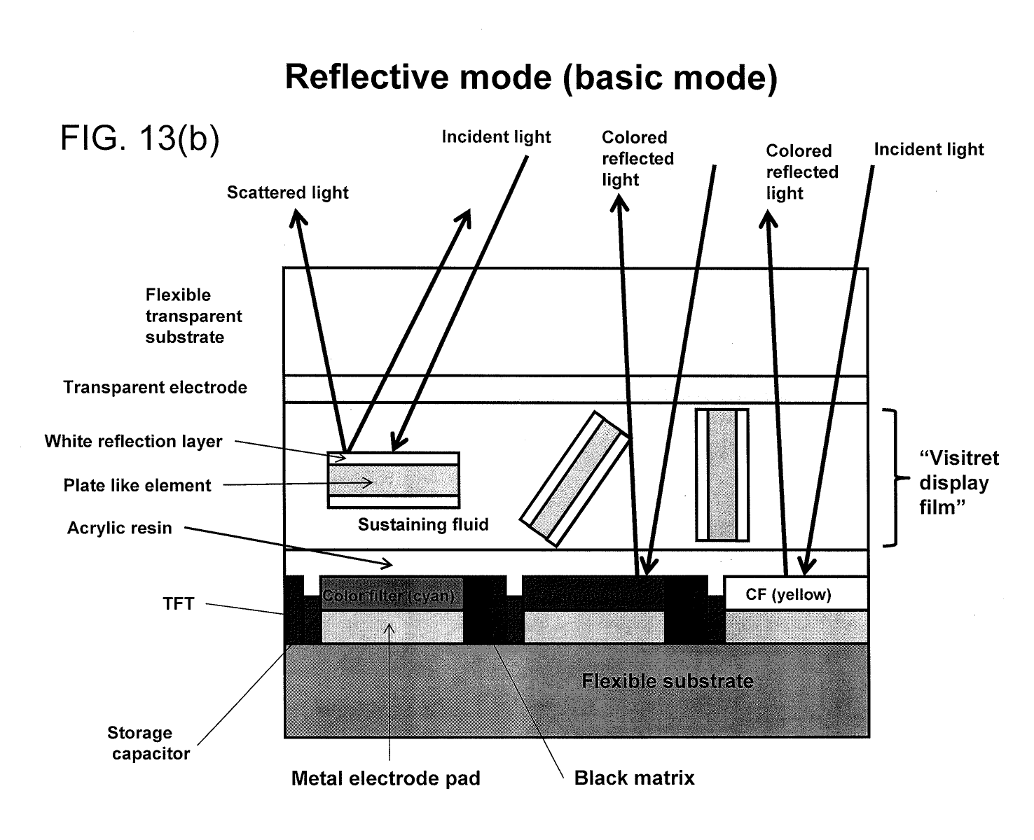

FIG. 13(a) shows a reflective mode full color display based on this invention. This embodiment uses a flexible substrate as the back side from the perspective of a viewer as shown in FIG. 13(a). Using ambient light as illuminator light, when plate like element is oriented so that its white reflective layer faces the viewer, due to light scattering effect of the white reflection layer of the plate like element, ambient incident light is scattered and looks milky whitish color. When the plate like element tilts because of the externally applied electric field as shown in FIG. 13(a) (the magenta color filter portion in this drawing), some of incident light passes by the plate like element and reaches the color filter on the surface the flexible substrate. Some of light reaching the color filter penetrates color filter, and is reflected at the surface of the reflection layer (i.e., metal electrode) placed behind the color filter as shown in FIG. 13(a). Light reflected by the reflection layer passes through magenta color filter again, and the total light throughput is somewhat limited, because of the double passes of the magenta color filter layer. However, the reflected light gives good color purity to a viewer.

As discussed above, depending on the tilting angle of the plate like element, colored reflected light strength is tunable, which provides continuous colored light intensity (gradation), resulting in full color image. In FIG. 13(a), between the display medium (i.e., the plate like elements and their suspending medium) and the surface of the flexible substrate, there is an acrylic resin layer. This layer is formed for surface planarization purpose both in terms of physical surface topography and optical reflective index matching purposes. Both physical topography planarization and optical reflective index matching minimize unnecessary light reflection and light scattering at the interface between two materials, which degrades color purity as well as contrast ratio specifically for reflective type of displays. Although FIG. 13(a) does not show same type of acrylic resin layer between the display medium and the front side (near to viewer's side), depending on the reflective index of transparent electrode and/or that of substrate material, it is effective to minimize unnecessary reflection and light scattering from the interface.

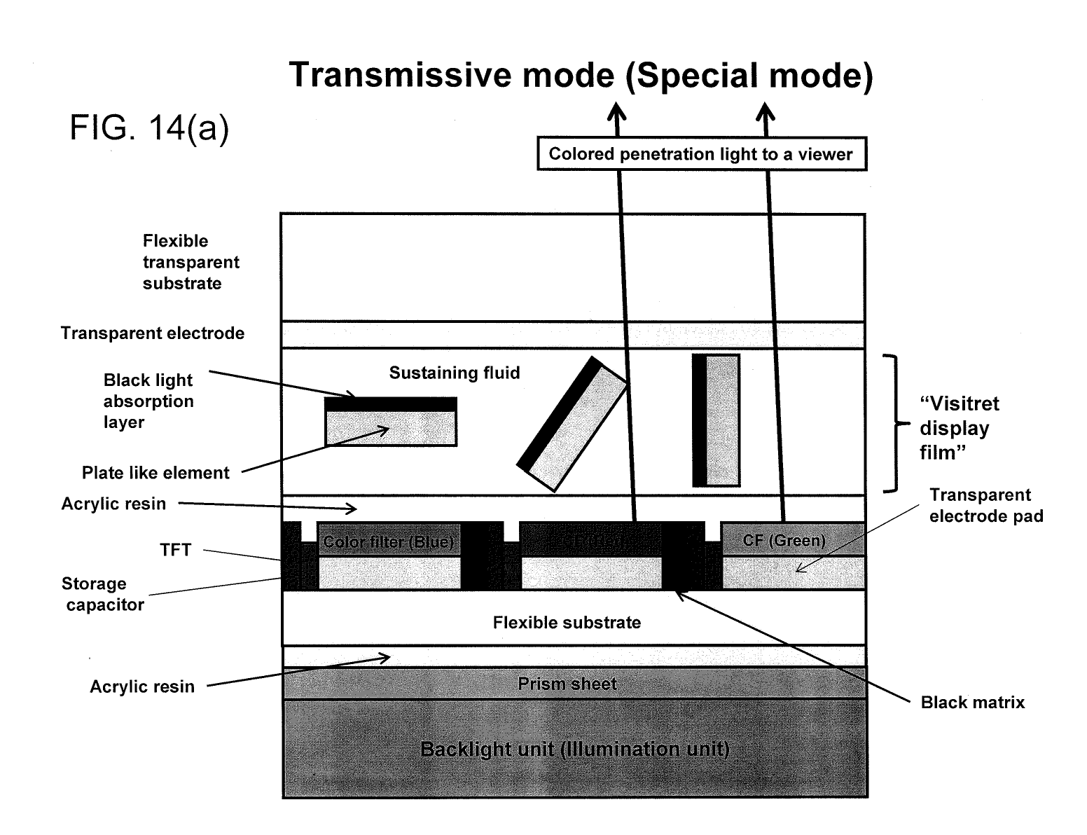

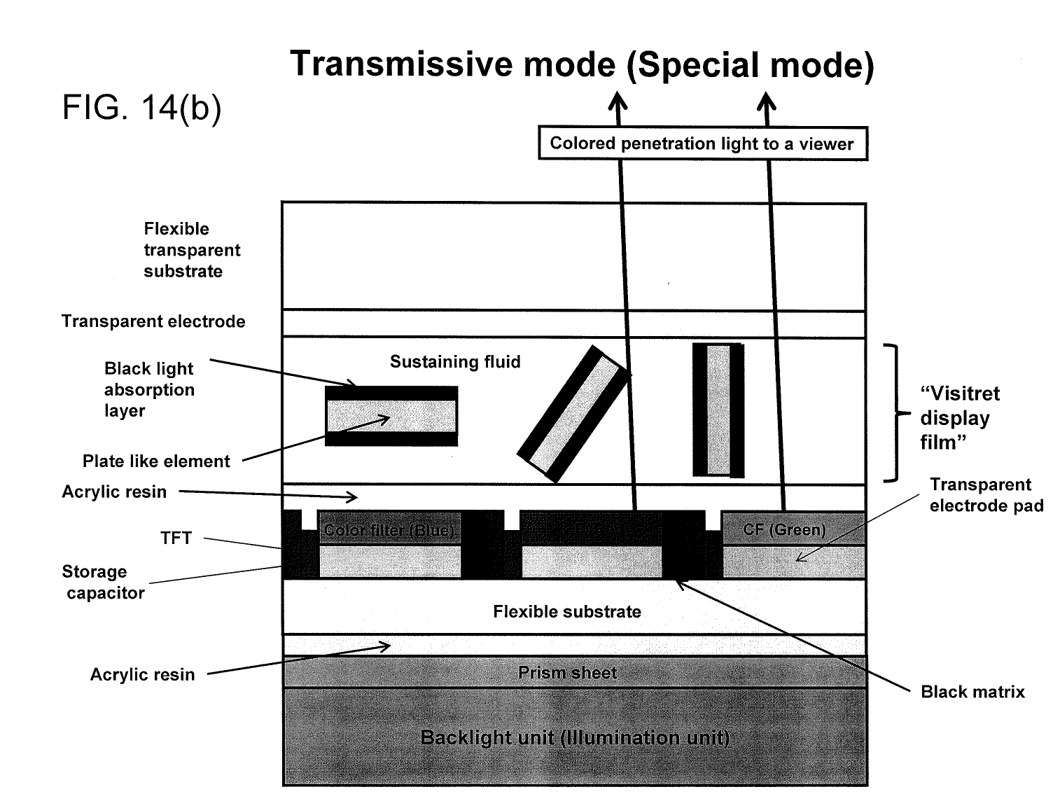

FIG. 13 (b) shows the plate like display element has both sides covered by white scattering layers. Depending on the selection of white light scattering layer materials and/or ferroelectric plate like element materials, in some cases, even single white light scattering layer is not enough to reflect and scatter incident light, and/or some incident light passes through both white layer and ferroelectric layer, resulting in degradation of display performance. In such a case, both sides of plate like display element would be covered by white light scattering layers. One side or double sides covering by light scattering layers or light absorption layers as shown in FIG. 14 (a) and FIG. 14 (b) also needs consideration of influence on power of spontaneous polarization of the original display element. Since both white and black layer materials are dielectric materials, and more or less they have some influence on power of spontaneous polarization as a stack of dielectric material layers. Therefore, selection of display configuration in terms of single or double layer coverage is decided by comprehensive factors such as display performance, power consumption and so on.

FIGS. 14(a) and 14(b) show a transmissive-mode full color display based on the invention. The transmissive mode requires a backlight unit to produce good enough color image regardless ambient light condition. This transmissive mode display is also equipped with a prism sheet between the switching element layer and the backlight to maximize light efficiency. Depending on reflective index matching situation, an acrylic resin layer may be inserted between the prism sheet and the back side of substrate for effective use of backlight flux. Black matrix is also provided for avoiding color mixing between neighboring colors, and increase contrast ratio. In the transmissive mode display device, due to the additive color reproduction system, either one side or two side surfaces of the plate like elements are covered by black material.

FIG. 14 (a) shows a display device in which only a one side of the plate like element is covered by a black dye later, and FIG. 14 (b) shows a display device in which both sides of the plate like element are covered by a black dye layer. In this particular configuration, both sides covering is effective to have a higher contrast ratio with relatively strong illumination light flux, and single side covering is suitable for providing less power consumption display unit with a little less contrast ratio compared to the both side covering. This means that the single black layer module is relatively suitable for smaller screen and in-door type of application, and the double-sided black layer module is relatively suitable for large screen out-door applications, however, it is up to consideration among screen luminance, contrast ratio and power consumption.

With respect to the arrangement of each plate like display element in a panel is decided by the spontaneous polarization direction of ferroelectricity of each display element. For instance, when a sheet shaped ferroelectric material is made of a polymer such as PVDF, the direction of spontaneous polarization is pre-set such as the sheet thickness direction from the bottom side to the top side. Therefore, when the black dye layer sheet is laminated on the ferroelectric sheet material, the relative direction between the black layer and the direction of spontaneous polarization is designed to set its direction. This relative direction design situation is the same as the covering layer of white light scattering material. When both sides of the display element are covered by only black or only white, or one side with black and the other side white layer, the direction of spontaneous polarization is always pre-identified. When the display element is chosen from Perovskyte ceramics materials such as BaTiO3 particle, as long as the coloration process is followed by ferroelectric ready materials, which means the base display element is pre-set of its ferroelectric property, it is possible to detect the specific spontaneous polarization direction. Even the spontaneous polarization direction is unknown for some reason, after the display elements are filled with their suspending fluid in a display panel, and a specific direction polarity electric field is applied to the panel, all of ferroelectric based display elements aligned single uniform direction along with the specific electric field direction, therefore, the initial display element direction is easily aligned. In this transmissive mode, when plate like element aligns almost parallel to the color filter substrate, display shows black image. When, the plate like element has some tilt as shown in FIG. 14, the display shows a specific color depending on the tilt angle of the plate like element which is controlled by the applied electric field.

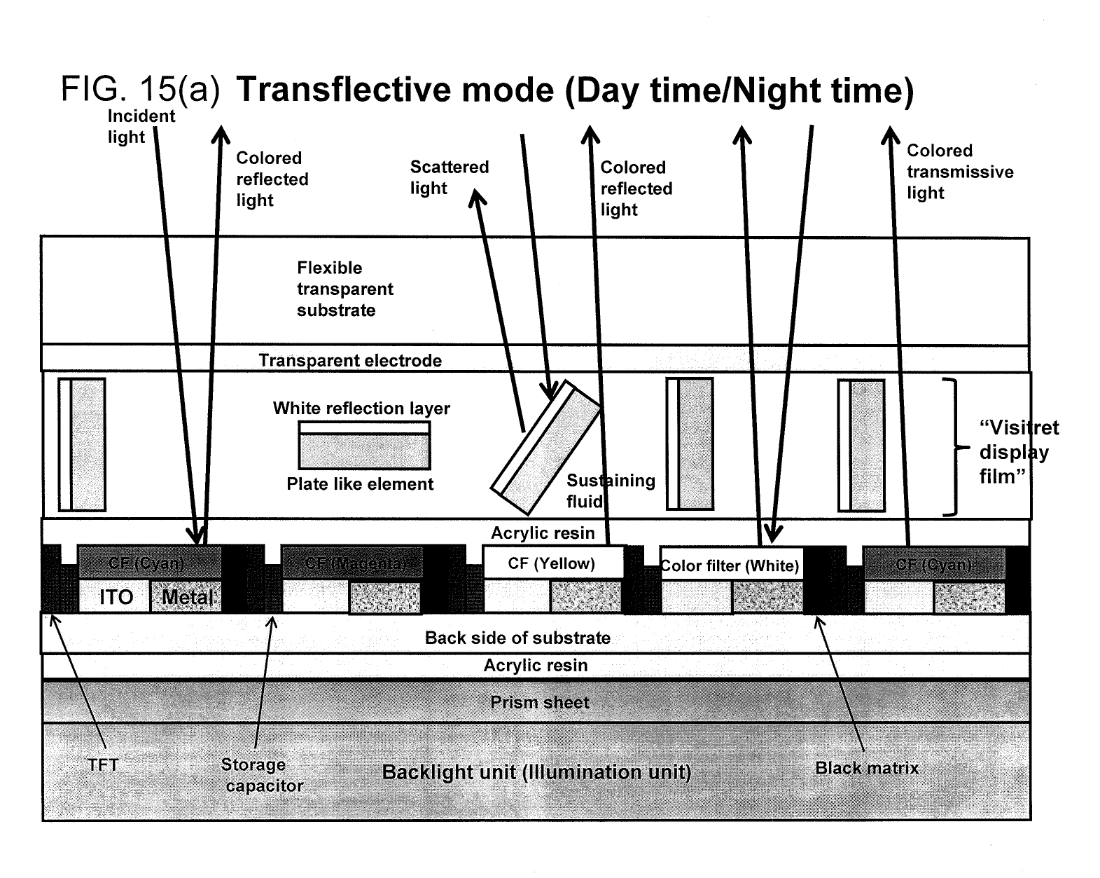

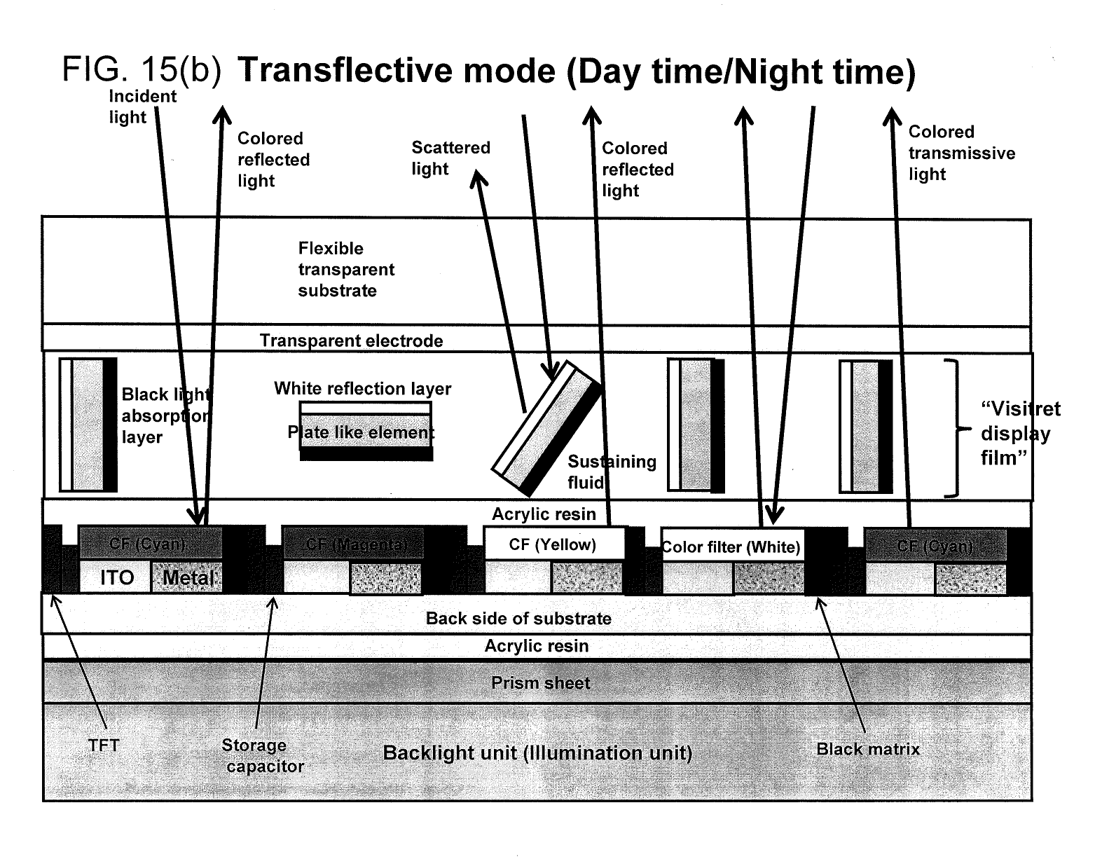

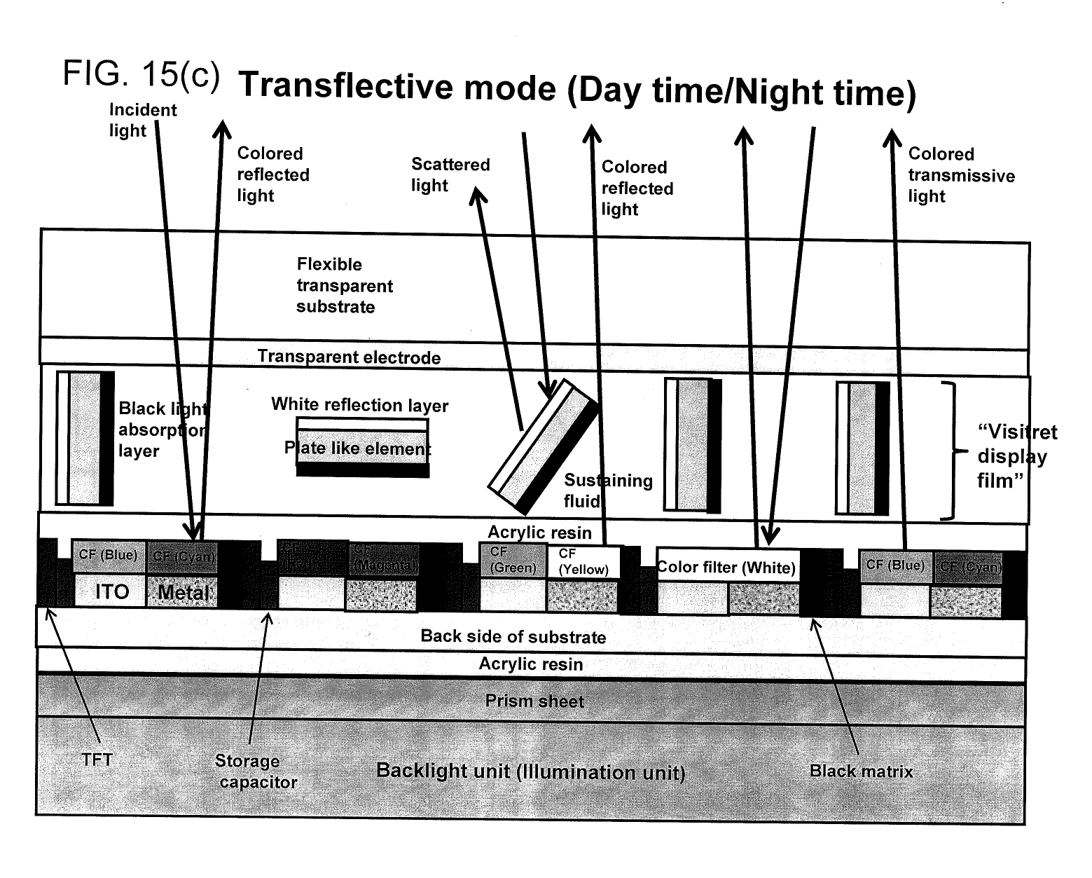

The other configurations of this display system are shown in FIGS. 15(a), 15(b) and 15(c). These configurations have both subtract color and additive color systems in the same panel. As shown in FIGS. 15(a), 15(b) and 15(c), these configurations have both transparent electrode and reflective electrodes in a single panel. Depending on ambient brightness level, and required display specification, these display systems realize both reflective display image and transmissive backlighted image as their primary function. Using the display modules shown in FIGS. 15(a), 15(b) and 15(c), when ambient light is bright enough such as sun light condition, backlight unit is off and the display module is used as a reflective display. In this case, due to bright enough ambient light condition, this display module works as a reflective display as explained with FIGS. 13(a) and 13(b). Strong enough incident light is reflected by the reflection layer placed behind each color filter layer, so colored light reaches viewer's eyes. When ambient light is relatively dim, this display module uses backlight unit as its own illuminator. Switching of the reflective mode and the backlight illuminator mode is controlled either manually or automatically with a specific ambient light detection system. For a backlight illuminated display module, it works as explained with FIGS. 14(a) and 14(b).

Unlike the reflective only display or the backlight illuminated only display, the transflective display in FIGS. 15(a), 15(b) and 15(c) have a specific design in terms of color filter mixing method that is whether additive or subtract color modes, or mixing both additive and subtract, and/or ratio of transmissive and reflective area at each pixel depending on specific use conditions. If reflective use opportunity is major use, its reflective area would be larger than that the transmissive area at each pixel. If transmissive use is major, the transparent pixel area would be larger than the reflective area at each pixel. Also, depending on the major use model, or other requirement, selection of primary color combination of color filters is also considerable. In general, if reflective use is the major, subtract color combination would be selected. If major use model is transmissive mode, additive color mixing would be chosen. Also depending on the choice of additive and/or subtract color mixing, surface reflection/absorption materials such as white light scattering and/or black light absorption layer would be selected to maximize display performance.

In some cases, both light reflection layer and light absorption layers are attached to both sides of plate like element. However, depending on specific requirement of display contents, combination of color mixing is decided. The color filter selection is not limited to the one shown in the drawings. Depending on application, other selection of color filters may be used. The difference in design configuration between FIGS. 15(a) and 15(b) is the use of single light scattering layer on the plate like display element (FIG. 15(a)), or the use of the light scattering layer on one side and the light absorption layer on the other side. As discussed above, if the FIG. 15 type of display module configuration is applied to mainly out-door application that requires sun light readability with good enough ambient light condition, the display shown in FIG. 15 (b) having the other side covered by the light absorption layer would be better than not having the black light absorption layer.

Since most of out-door display applications are required relatively large screen such as over 300-inch diagonal, wider viewing angle is one of the important requirement. Due to wide viewing angle readability, some incident light comes from shallow angles. Those very shallow incident angle light may penetrates the plate like display elements, resulting in back ground undesirable display image. In order to avoid such a problem, having a reflective layer on one side of the plate like element and an adsorption layer on the other side of the plate like element is effective. However, due to the light absorption layer, some incident light which is used for actual display image is also lost. Therefore, the selection of covering layers for the plate like display element would be on consideration of actual display application conditions. The difference between FIGS. 15(b) and 15(c) is color purity in principle. As FIG. 15(c) shows, this particular configuration has both additive and subtract color mixing functions. Since a reflective portion of the pixel equipped with a metal non-light-transmissive electrode does not allow backlight light flux passing through that portion of pixel, subtract color filter system does not have any contribution to the light transmissive display mode using backlight illumination. For transmissive use, only transparent electrode portion at each pixel contributes display image. In the display shown in FIG. 15(c), the additive color mixing consisting of Red, Green and Blue color filters is applied on transparent electrode, and the subtract color mixing consisting of Cyan, Magenta and Yellow color filters is applied on reflective electrode. In FIGS. 15(a), 15(b) and 15(c), a white color filter pixel is also equipped. Regardless reflective or transmissive, white a color filter is effective to have brighter image, in particular for out-door and/or large screen display systems.

4. Drive Mechanism of the Plate Like Element

The plate like element includes a ferroelectric material. One example of this plate like material is made of a ferroelectric polyvinyl Vinyliden (PVDF). A sheet shape ferroelectric PVDF of a proper thickness is cut to small pieces. For instance, a 40 micron thickness ferroelectric PVDF sheet is cut into around 200 micron×200 micron square shaped pieces. These small plate like ferroelectric PVDF elements are mixed with a thixotropic fluid. A well prepared thixotropic medium mixed with the ferroelectric PVDF elements are put through a narrow height pass, such as up to 500 micron height. This low profile flow naturally induces alignment of plate like particles almost parallel to the flow direction.

Once each ferroelectric plate like element is aligned almost parallel to the fluid flow, this fluid is filled in up to 300 micron height of panel gap. Since spontaneous polarization is perpendicular to the film thickness, filled display medium shows their spontaneous polarization perpendicular to panel substrates. Then, if necessary, applying a voltage in the same direction to whole pixel elements makes all of spontaneous polarization direction align exactly in the same direction. A particle behavior under thixotropic sustaining medium is described in International Application No. PCT/EP2010/057865.

### Example (1)

A ferroelectric PVDF sheet, the thickness of which was 40 μm, was used. A TiO₂ dispersed sheet was laminated on a surface of the PVDF sheet. The TiO₂ dispersed sheet was 10 micron thick with the base sheet material made of a polyethylene. This laminated sheet was cut into squares of an average size of 200 μm×200 m by using a sharp square stainless steel chip. For the thixotropic suspending medium, a 5 centi-strokes silicon fluid (Aldrich Chemicals) and fumed silicon dioxide flakes were mixed with 5:1 weight ratio. After those two were completely mixed, 5 weight % of above prepared cutouts of PVDF particles were mixed with the thixotropic fluid. The original PVDF sheet had 15 nC/cm² of spontaneous polarization.

This mixture formed a fairly viscous colloidal fluid. In order to stabilize the fluid, after this fluid was left 24 hours at room temperature, this fluid was moved to next step of the experiment. Both cyan and yellow pigment based color filter glass substrates were prepared. These color filtered substrates also had metal reflective electrodes made of an aluminum layer with the color filters. The thickness of aluminum electrode was 2,500 Å, cyan color filter thickness was 0.7 micron, and yellow color filter thickness was 0.8 micron. The other side of glass substrate was equipped with 1,500 Å thick transparent electrodes. Using 300 micron spacer film, two glass substrates were formed to have a 300 micron gap. In this gap, the thixotropic display medium described above was filled by sacking up the medium from one edge of the panel using absorption pump. After the panel gap was filled with the thixotropic medium, all of open areas between two glass substrates were glued by epoxy sealant. Using a rectangular waveform voltage of 250 V with 30 Hz, the response was measured. Using a white scattering light source, this panel showed good enough results, as shown in Table 2.

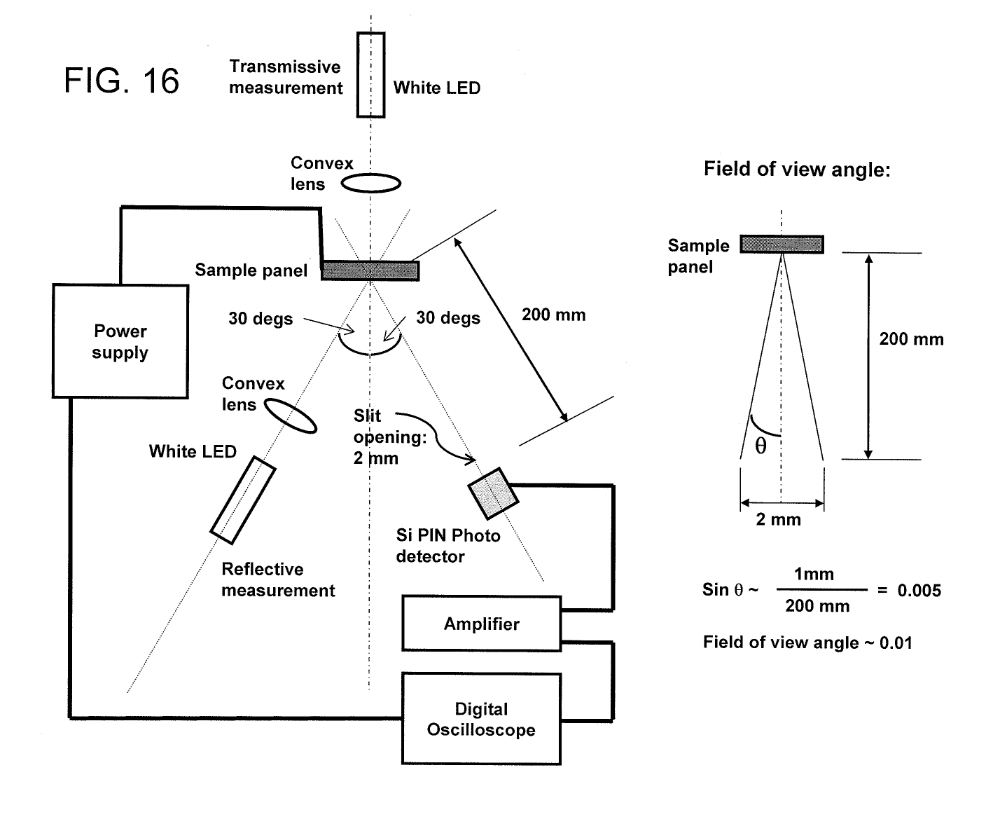

The measurement results shown in Table 2 were obtained by using reflective optical set-up illustrated in FIG. 16. White LED light source was focused on the sample panel surface by concave lens with 30 degrees angle from the panel surface normal as shown in FIG. 16. The reflected light from the sample panel was detected with the field view angle of 0.01 deg. as illustrated in FIG. 16. The detected light by Si-PIN photodiode was amplified and was put to digital oscilloscope by synchronized with applied electric field to the sample panel. Color reproduction was confirmed by naked eyes at the sample panel surface using the same optical set-up.

As Table 2 summarizes basic display performance of this example. It showed good enough optical density. Compared to newspaper's optical density of 0.5, in general, this example showed better optical density than that of newspaper. Also, the reflectivity is 35% that is good enough as a reflective display as well as confirmation of each subtract primary color reproduction capability.

In order to confirm the gray shade display capability, two types of drive voltages were applied. One was 180 V with 30 Hz rectangular waveform, and the other was 250 V with 90 Hz rectangular waveform. Compared to drive voltage of 250 V with 30 Hz rectangular waveform, 180 V with 30 Hz showed about half of the light intensity, and 250 V with 90 Hz showed about ⅔ of the light intensity.

TABLE 2

| | Optical density | Reflectivity | Color coordinate |
|---|---|---|---|
| Example 1 | 1.0 | 35% | Cyan, Yellow |
| | | | Green, Black, White |

### Example (2)

A ferroelectric PVDF sheet, the thickness of which was 40 μm, was used. A carbon based dyed dispersed sheet was laminated on one surface of the PVDF sheet. The carbon dispersed sheet was 10 micron thick with a base sheet material made of a polyethylene. This laminated sheet was cut into squares of an average size of 200 μm×200 μm by using a sharp square stainless steel chip. For the thixotropic suspending medium, a 5 centi-strokes silicon fluid (Aldrich Chemicals) and fumed silicon dioxide flakes were mixed with 5:1 weight ratio. After those two were completely mixed, 5 weight % of above prepared cutouts of PVDF particles were mixed with the thixotropic fluid. The original PVDF sheet had 12 nC/cm² of spontaneous polarization.

This mixture formed a fairly viscous colloidal structured fluid. In order to stabilize the fluid, after this fluid was left 24 hours at room temperature, this fluid was moved to the next step of the experiment. Using Red, Blue and Green color filters with transparent electrode substrates as shown in FIGS. 13-15, a panel was prepared. The thickness of each color filter was Red: 0.8 micron, Blue: 0.7 micron, and Green: 0.9 micron. All of these color filters were based on pigment dispersion type. The transparent electrode was 1,500 A thick. The other side of glass substrate was equipped with a 1,500 Å thick transparent electrode. Using a 300 micron spacer film, two glass substrates were formed to have a 300 micron gap. In this gap, the thixotropic display medium thus prepared was filled by sacking up the medium from one edge of the panel using absorption pump. After the panel gap was filled with the thixotropic medium, all of open areas between two glass substrates were glued by epoxy sealant. Using a rectangular waveform of 250 V with 30 Hz, the response was measured. This panel showed good enough results, as shown in Table 3.

The measurement results shown in Table 3 were also obtained by using transmissive optical set-up illustrated in FIG. 16. White LED light source was focused on the sample panel surface by concave lens with the panel surface normal as shown in FIG. 16. The transmitted light from the sample panel was detected with the field view angle of 0.01 deg. from 30 degrees tilted angle from the panel surface normal as illustrated in FIG. 16. The detected light by Si-PIN photodiode was amplified and was put to digital oscilloscope by synchronized with applied electric field to the sample panel. Color reproduction was confirmed by naked eyes at the sample panel surface using same optical set-up. As listed in Table 3, this example showed good enough optical density. i.e., 1.2. This optical density level is close to good quality of a printed paper. Moreover, light throughput of 65% is much higher than those of general color filtered liquid crystal displays. Table 3 also confirmed primary additive color reproduction capability as shown in the table.

For gray shade display capability confirmation, the same types of different voltages and frequencies were applied to this configuration as applied in Example 1. In this configuration, compared to the drive voltage of 250 V with 30 Hz of rectangular waveform, 180 V with 30 Hz showed about ⅔ of the light intensity, and 250 V with 90 Hz showed about ¾ of the light intensity.

TABLE 3

| | Optical density | Transmittance | Color coordinate |
|---|---|---|---|
| Example 2 | 1.2 | 65% | Red, Green, Blue |
| | | | White, Black |

### Example (3)

A ferroelectric PVDF sheet, the thickness of which was 40 μm, was used. The PVDF sheet had its spontaneous polarization direction perpendicular to the sheet surface, and the same TiO₂ dispersed sheet as Example 1 was laminated on one surface of the PVDF sheet that was a negatively polarized direction. The TiO₂ dispersed sheet was 10 micron thick with the base sheet material made of a polyethylene. The same carbon based dyed dispersed sheet as Example 2 was laminated on the other surface of the PVDF that was positively charged direction. Both surfaces of the PVDF were laminated with white and black sheets. This laminated sheet was cut into squares of an average size of 200 μm×200 μm by using a sharp square stainless steel chip. For the thixotropic suspending medium, a 5 centi-strokes silicon fluid (Aldrich Chemicals) and fumed silicon dioxide flakes were mixed with 5:1 weight ratio. After those two were completely mixed, 5 weight % of above prepared cutouts of PVDF particles were mixed with the thixotropic fluid. The original PVDF sheet had 20 nC/cm² of spontaneous polarization.

This mixture formed a fairly viscous colloidal fluid. In order to stabilize the fluid, after this fluid was left 24 hours at room temperature, this fluid was moved to the next step of the experiment. Both metal reflective and ITO transparent electrodes were prepared on a glass substrate. These metal reflective electrodes were prepared in the same manner as Example 1 with forming cyan color filter on it. In the same substrate, transparent electrode (ITO) was formed as same as Example 2 with red color filter on it. The counter glass substrate was coated with transparent electrode the same manner as Examples 1 and 2. Using a 300 micron spacer film, two glass substrates were formed to have a 300 micron gap. In this gap, the thixotropic display medium was filled by sacking up the medium from one edge of the panel using absorption pump. After the panel gap was filled with the thixotropic medium, all of open areas between two glass substrates were glued by epoxy sealant. This prepared sample panel configuration is the same as in FIG. 15(c). Using a rectangular waveform of 250 V with 30 Hz, the response was measured. Using white scattering light source in both reflective and transmissive modes, this panel showed the results shown in Table 4.

The measurement results shown in Table 4 were also obtained by using both reflective and transmissive optical set-up, respectively illustrated in FIG. 16. For reflective measurement, as is the case with Example 1, white LED light source was focused on the sample panel surface by concave lens with 30 degrees angle from the panel surface normal as shown in FIG. 16. For transmissive measurement, as is the case with Example 2, white LED light source was focused on the sample panel surface by concave lens with the panel surface normal as shown in FIG. 16. The reflected light from the sample panel was detected with the field view angle of 0.01 deg. as illustrated in FIG. 16. The detected light by Si-PIN photodiode was amplified and was put to digital oscilloscope by synchronized with applied electric field to the sample panel. Color reproduction was confirmed by naked eyes at the sample panel surface using same optical set-up.

As listed in Table 4, this example showed good enough optical density, i.e., 1.2 for reflective display mode, and 1.1 for transmissive display mode, respectively. These optical density levels are close to good quality of printed paper. Moreover, light reflectivity of 37% and light throughput of 55% are much higher than those of general reflective type of liquid crystal displays and color filtered transmissive type of liquid crystal displays. Table 4 also confirmed primary color reproduction capability. For gray shade display capability confirmation, the same types of different voltages and frequencies as Example 1 and Example 2 were applied to this configuration. In this configuration, compared to drive voltage of 250 V with 30 Hz of rectangular waveform, 180 V with 30 Hz showed about ¾ of the light intensity, and 250 V with 90 Hz showed about ⅘ of the light intensity.

TABLE 4

| | Optical | Reflectivity, | |
|---|---|---|---|
| | density | Transmittance | Color coordinate |
| Example 3 | 1.2 | 37% | Cyan, Yellow |
| Reflective mode | | | Green, Black, White |
| Example 3 | 1.1 | 55% | Red, Green, Blue |
| Transmlssive mode | | | White, Black |

Transparent based switching element enables diversity of display applications from e-reader to large billboard displays. Unlike conventional electrophoretic display systems, this invention enables full color, full motion video image with the minimized power consumption. Transparent medium also enables both subtract full color reproduction using ambient bright enough light, and additive full color reproduction using specific backlight system. Even using backlight unit, due to its transparent nature, without any polarized control, provides maximum use of backlight use, resulting in high efficiency, low power consumption full motion video image. Moreover, unlike TFT-LCDs, TFT-OLEDs, and AC-PDPs, this invention provides full motion full-color displays and still color image with no power consumption. Therefore, depending on display contents requirements, this technology provides choices of power consumption using the same concept of configuration.

We claim:

1. An electrophoretic display device comprising:
a first electrode;
a second electrode; and
a transparent optical switching element disposed between the first and second electrodes, the optical switching element being configured to change an orientation in response to an electric field applied between the first and second electrodes.

2. The electrophoretic display device of claim 1, wherein the optical switching element is of a plate-like shape.

3. The electrophoretic display device of claim 2, wherein the optical switching element comprises a ferroelectric material.

4. The electrophoretic display device of claim 2, further comprising a white colored light scattering layer disposed at least on a primary surface of the optical switching element of the plate-like shape.

5. The electrophoretic display device of claim 2, further comprising a black colored light absorbing layer disposed at least on a primary surface of the optical switching element of the plate-like shape.

6. The electrophoretic display device of claim 2, further comprising an incident light scattering layer disposed on a primary surface of the optical switching element, an incident light absorbing layer disposed on a primary surface of the optical switching element, or an incident light scattering and an incident light absorbing layer disposed on primary surfaces of the optical switching element.

7. The electrophoretic display device of claim 1, further comprising a backplane and a color filter disposed between the optical switching element and the backplane.

8. The electrophoretic display device of claim 7, wherein the backplane is configured to produce color by light subtraction.

9. The electrophoretic display device of claim 7, wherein the backplane is configured to produce color by light addition from a backlight unit.

10. The electrophoretic display device of claim 7, wherein the backplane is configured to produce color by light subtraction and light addition from a backlight unit.
